(19) United States
(12) Patent Application Publication
(10) Pub. No.: US 2015/0302700 A1
(43) Pub. Date: Oct. 22, 2015

(54) GAMING SYSTEM AND METHOD FOR PROVIDING A GAME MODIFIER

(71) Applicant: IGT, Las Vegas, NV (US)

(72) Inventor: John H. Zielinski, Reno, NV (US)

(21) Appl. No.: 14/254,579

(22) Filed: Apr. 16, 2014

(51) Int. Cl. G07F 17/32; G07F 17/34

(52) U.S. Cl. CPC G07F 17/3267; G07F 17/34; G07F 17/3244

(57) ABSTRACT

A gaming system and method in which before, during and/or after one or more plays of a game, the gaming system randomly activates a game modifier generator. The activated game modifier generator randomly selects one of a plurality of different game modifiers. Following the random selection of a game modifier, the gaming system determines a duration for which the selected game modifier will be activated. For the determined duration, based on the selected game modifier, the gaming system modifies zero, one or more aspects, parameters or features of zero, one, or more plays of the game. Such modified aspects, parameters or features may result in the player winning additional awards in the plays of the game and/or winning awards in plays of previously unavailable bonus games.

### COPYRIGHT NOTICE

A portion of the disclosure of this patent document contains or may contain material, which is subject to copyright protection. The copyright owner has no objection to the photocopy reproduction by anyone of the patent document or the patent disclosure in exactly the form it appears in the Patent and Trademark Office patent file or records, but otherwise reserves all copyright rights whatsoever.

### BACKGROUND

Gaming machines which provide players awards in primary or base games are well known. Gaming machines generally require the player to place or make a wager to activate the primary or base game. In many of these gaming machines, the award is based on the player obtaining a winning symbol or symbol combination and on the amount of the wager (e.g., the higher the wager, the higher the award). Generally, symbols or symbol combinations which are less likely to occur usually provide higher awards. In such known gaming machines, the amount of the wager made on the base game by the player may vary. That is, different players play at substantially different wagering amounts or levels and at substantially different rates of play.

Secondary or bonus games are also known in gaming machines. The secondary or bonus games usually provide an additional award to the player. Secondary or bonus games usually do not require an additional wager by the player to be activated. Secondary or bonus games are generally activated or triggered upon an occurrence of a designated triggering symbol or triggering symbol combination in the primary or base game. For instance, a bonus symbol occurring on the payline on the third reel of a three reel slot machine may trigger the secondary bonus game. When a secondary or bonus game is triggered, the gaming machines generally indicates this to the player through one or more visual and/or audio output devices, such as the reels, lights, speakers, video screens, etc. Part of the enjoyment and excitement of playing certain gaming machines is the occurrence or triggering of the secondary or bonus game (even before the player knows how much the bonus award will be).

One known type of bonus game employs a wheel including several awards. In one such bonus game, a multi-colored award wheel is attached to the cabinet of the gaming machine. The award wheel is divided into several sections. Each section includes an award that ranges in value, such as from twenty-five to one-thousand. In this gaming machine, a player plays a base game that includes spinning reels and one or more paylines. In certain embodiments, the player obtains one opportunity or spin of the award wheel. The player spins the award wheel by pressing a button on the gaming device. Once the award wheel starts spinning, the player waits until it stops. An indicator located at the top of the award wheel points to a section of the wheel. The player receives the award on the indicated section for the bonus game. After the player receives that award, the player may resume playing the base game.

There is a continuing need to increase the level of excitement and entertainment for people playing gaming machines

### SUMMARY

The present disclosure relates generally to gaming systems and methods for randomly modifying one or more aspects, parameters or features of a game for a limited duration.

In various embodiments, before, during and/or after one or more plays of a game, the gaming system randomly activates a game modifier generator. The activated game modifier generator randomly selects one of a plurality of different game modifiers and the gaming system determines a duration which the selected game modifier will be activated. For the determined duration, the gaming system modifies, based on the selected game modifier, zero, one or more aspects, parameters or features of zero, one, or more plays of the game. Such modified aspects, parameters or features may result in the player winning additional awards in any plays of the game during the determined duration and/or winning awards in plays of previously unavailable bonus games triggered in association with any plays of the game during the determined duration. Such a configuration thus creates a frenzy of increased player excitement and entertainment by randomly enhancing certain aspects of the player's game and maintaining the enhanced aspects for a limited duration.

In various embodiments, the gaming system includes one or more game modifier generators. Each game modifier generator includes a plurality of game modifiers that, when activated, modify one or more aspects, parameters or features of one or more plays of one or more games. For example, one or more game modifiers modify, when activated, one or more features of a primary game, such as which symbols are available to be generated in a play of the primary game, the awards available in a play of a game, and the availability of additional award opportunities associated with a play of a game.

In operation, the gaming system activates the game modifier generator upon an occurrence of a game modifier triggering event. In one embodiment, a game modifier triggering event occurs independent of any displayed event in any play of any game. In another embodiment, the gaming system tracks the occurrences of one or more suitable events occurring in association with one or more games and determines, based on these tracked events, whether a game modifier triggering event occurs. In another embodiment, the gaming system defines one or more game play parameters, such as a wager amount or a maximum wager amount, wherein the gaming system determines whether a game modifier triggering event occurs based on a player's tracked game play activity satisfying the defined parameter. In another embodiment, the gaming system causes a game modifier triggering event to occur based on (or as a result of) one or more displayed events occurring in association with one or more plays of one or more games.

Once the gaming system activates the game modifier generator, the game modifier generator randomly selects one of a plurality of game modifiers to activate. The gaming system then determines a duration for which the selected game modifier remains activated. For example, the game modifier generator randomly selects the game modifier of a bonus symbol, (which is otherwise unavailable to be generated during a play of the primary game, and which if generated, triggers a play of an otherwise unavailable bonus game). In this example, the gaming system determines that the selected bonus symbol will be activated for the next ten plays of the game.

In addition to randomly selecting a modifier and activating that modifier for a limited duration, the gaming system enables a player to initiate a play of a primary game, wherein such a primary game is modified by any features of any activated game modifiers. It should thus be appreciated that whether or not one or more modified features of the game are employed is based on which modifiers, if any, are activated during the play of the game. Such a configuration thus provides that different plays of a game will employ different features based on when such plays are initiated and which modifiers have previously been selected for activation.

For each of any plays of the primary game during the determined duration, for one or more activated modifiers, the gaming system provides the feature associated with the currently activated game modifier. Continuing with the above example, after the game modifier of a bonus symbol is activated, for the next ten plays of the primary game, the gaming system modifies the primary game symbol set to include the otherwise unavailable bonus symbol. In this example, any of the ten plays of the modified primary game, the gaming system generates the bonus symbol, the gaming system triggers the otherwise unavailable bonus game and provides one or more additional opportunities for the player to win one or more awards.

Such a configuration creates a gaming system and method for randomly, modifying one or more parameters of a game for a limited duration. This creates a frenzy of increased player excitement and entertainment by randomly enhancing certain aspects of the player's game and maintaining the enhanced aspects for a limited duration.

Additional features and advantages are described herein, and will be apparent from the following Detailed Description and the figures.

### BRIEF DESCRIPTION OF THE FIGURES

FIGS. 1A and 1B illustrates flowcharts illustrating an example method of operating one embodiment of the gaming system of the present disclosure.

FIGS. 2A, 2B, 2C, 2D, and 2E illustrate screen shots of one example of the gaming system of the present disclosure operating a primary game.

FIG. 3 illustrates a timeline for multiple plays of a game of one embodiment of the present disclosure.

FIG. 4A is a schematic block diagram of one embodiment of a network configuration of the gaming system disclosed herein.

FIG. 4B is a schematic block diagram of one embodiment of an electronic configuration of the gaming system disclosed herein.

FIGS. 5A and 5B are perspective views of example alternative embodiments of the gaming system disclosed herein.

### DETAILED DESCRIPTION

### Temporarily Activating Game Modifiers

In various embodiments, the gaming system disclosed herein randomly modifies one or more aspects, parameters or features of a game for a limited duration. In various embodiments, before, during and/or after one or more plays of a game, the gaming system randomly activates a game modifier generator. The activated game modifier generator randomly selects one of a plurality of different game modifiers and the gaming system determines a duration for which the selected game modifier will be activated. For the determined duration, the gaming system modifies, based on the selected game modifier, zero, one or more aspects, parameters or features of zero, one, or more plays of the game. Such modified aspects, parameters or features may result in the player winning additional awards in any plays of the game during the determined duration and/or winning awards in plays of previously unavailable bonus games triggered in association with any plays of the game during the determined duration.

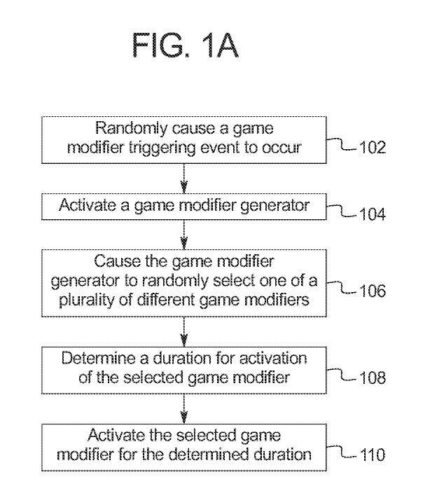

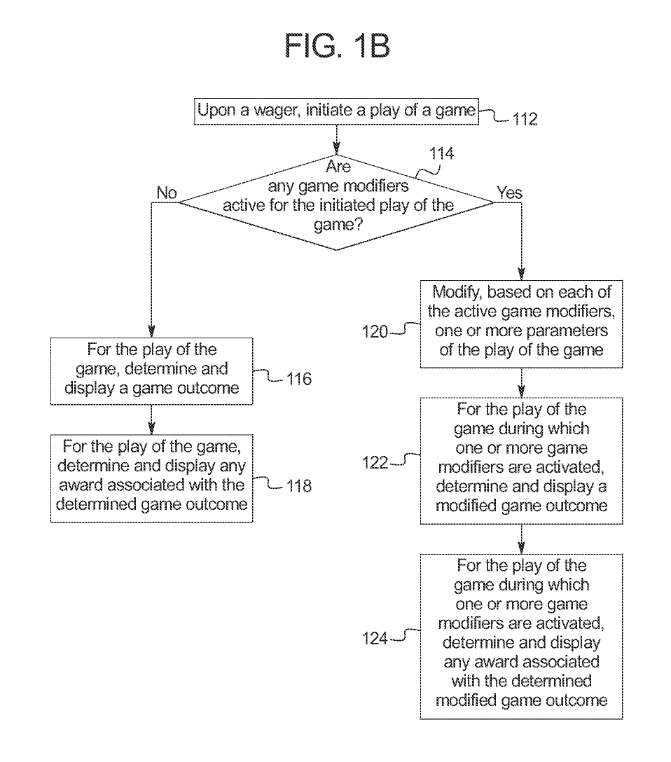

Referring now to FIGS. 1A and 1B, which illustrate a flowcharts of an embodiment of a process for operating a gaming system disclosed herein. In one embodiment, this process is embodied in one or more software programs stored in one or more memories and executed by one or more processors or servers. Although this process is described with reference to the flowcharts illustrated in FIGS. 1A and 1B, it should be appreciated that many other methods of performing the acts associated with this process may be used. For example, the order of certain of the illustrated blocks and/or diamonds may be changed, certain of the illustrated blocks and/or diamonds may be optional, and/or certain of the illustrated blocks and/or diamonds may not be employed.

While certain of the embodiments described below are directed to employing game modifier generators in association with a primary or base game, it should be appreciated that the present disclosure may additionally or alternatively be employed in association with employing game modifier generators in association with a secondary or bonus game. Moreover, while the player's credit balance, the player's wager, and any awards are displayed as an amount of monetary credits or currency in the embodiments described below, one or more of such player's credit balance, such player's wager, and any awards provided to such player may be for non-monetary credits, promotional credits, and/or player tracking points or credits.

Turning to FIG. 1A, which illustrates a flowchart of an embodiment of a game modifier selection and activation process for operating a gaming system disclosed herein. In operation of this embodiment, the gaming system randomly causes a game modifier triggering event to occur, as indicated by block 102. Such an event occurs before, after or during a play of a game has been initiated. For example, in one embodiment, after a play of the game is initiated, a set of reels spin for the play of the game and the game modifier generator randomly selects a modifier to be utilized in the initiated play of the game. Alternatively, the game modifier can be used in the next initiated play of the game. In one embodiment, a game modifier triggering event randomly occurs independent of any displayed event in any play of any game.

Once the game modifier triggering event randomly occurs, the gaming system activates a game modifier generator, as indicated by block 104. Each game modifier, when activated, modifies one or more aspects, parameters or features of one or more plays of one or more games.

Once the game modifier generator is activated, the gaming system causes the game modifier generator to randomly select one of a plurality of different game modifiers as indicated by block 106. After the game modifier generator randomly selects the game modifier, the gaming system determines a duration for which to activate the selected game modifier as indicated by block 108. After determining the duration for the activation of the game modifier, the gaming system activates the selected game modifier for the determined duration as indicated by block 110.

Turning to FIG. 1B, which illustrates a flowchart of an embodiment of a game initiation process for operating a gaming system disclosed herein. In operation of this embodiment, upon receiving a wager, the gaming system initiates a play of a game, as indicated by block 112. Upon the initiation of a play of a game, the gaming system determines whether any game modifiers are activated for the initiated play of the game, as indicated by the diamond 114. If there are no activated game modifiers, the gaming system determines and displays a game outcome for the play of the game, as indicated by block 116. The gaming system then determines and displays any award associated with the determined game outcome for the play of the game as indicated by block 118.

If, on the other hand, one or more game modifiers are activated, the gaming system modifies, based on each of the activated game modifiers, one or more parameters of the play of the game as indicated by block 120. Such modified parameters may result in the player winning additional awards in any plays of the game during the determined duration and/or winning awards in plays of previously unavailable bonus games triggered in association with any plays of the game during the determined duration.

For a play of the game during the duration in which one or more modifiers are activated, the gaming system determines and displays a game outcome as indicated by block 122. For a play of the game during which one or more modifiers are activated, the gaming system determines and displays an award associated with the determined award. It should be appreciated that the modified parameters may or may not modify the outcome determined for the play of the game. As will be described in greater detail below, certain game modifiers modify a parameter of the game such that the player is provided an opportunity for a modified outcome during the determined duration if the gaming system generates a designated symbol combination. That is, for certain game modifiers, the modification of the game outcome is still based on a random generation of certain designated symbols. Thus, a player may or may not receive a modified game outcome during the determined duration.

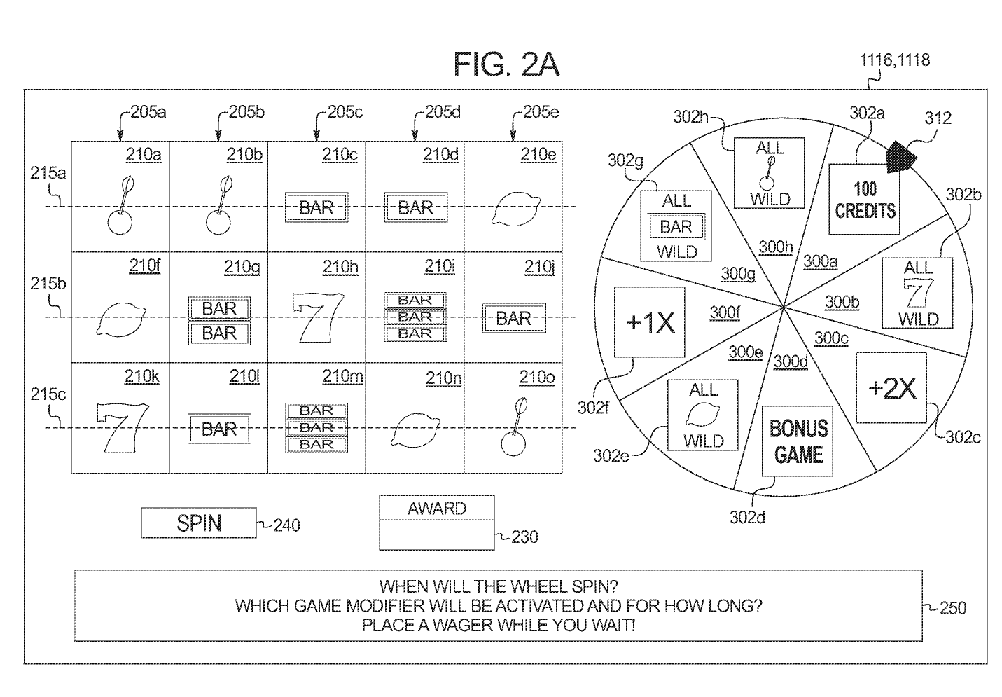

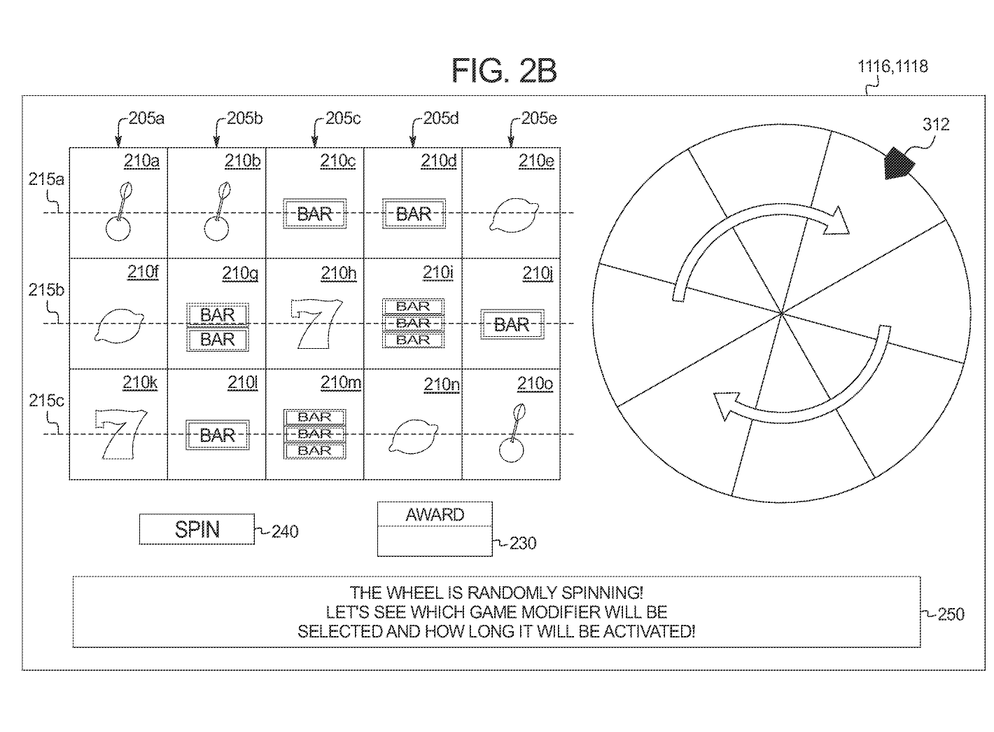

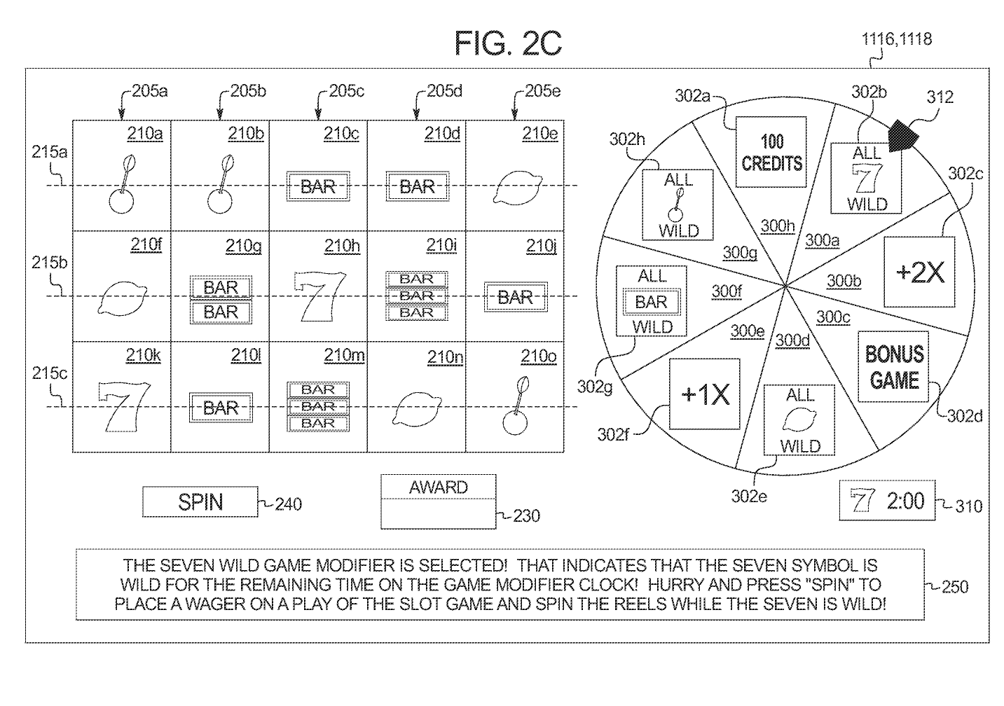

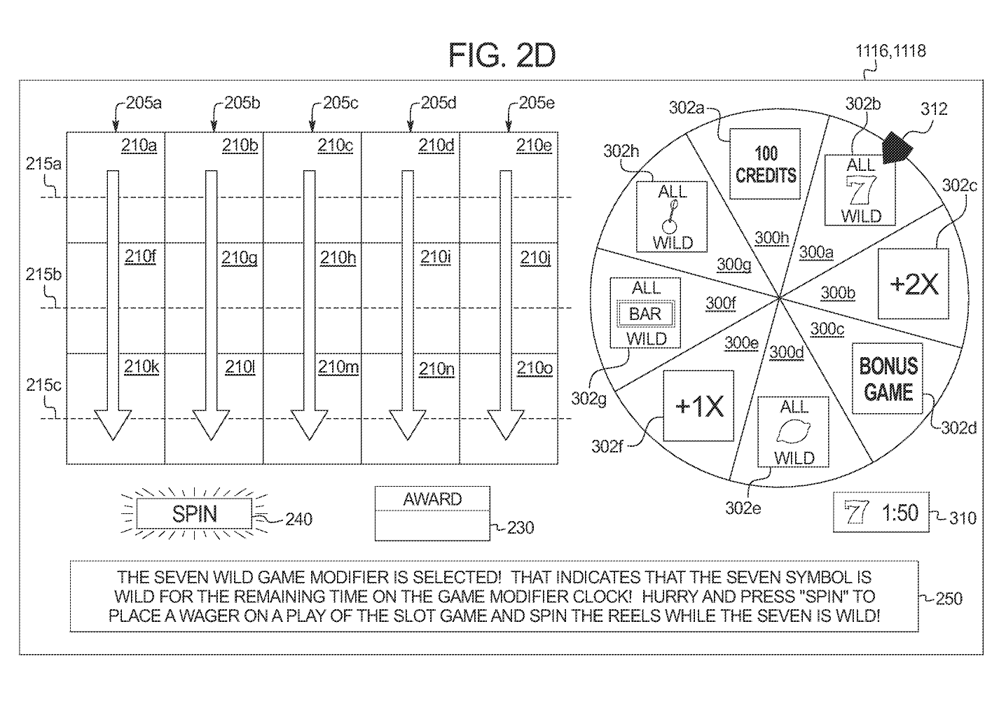

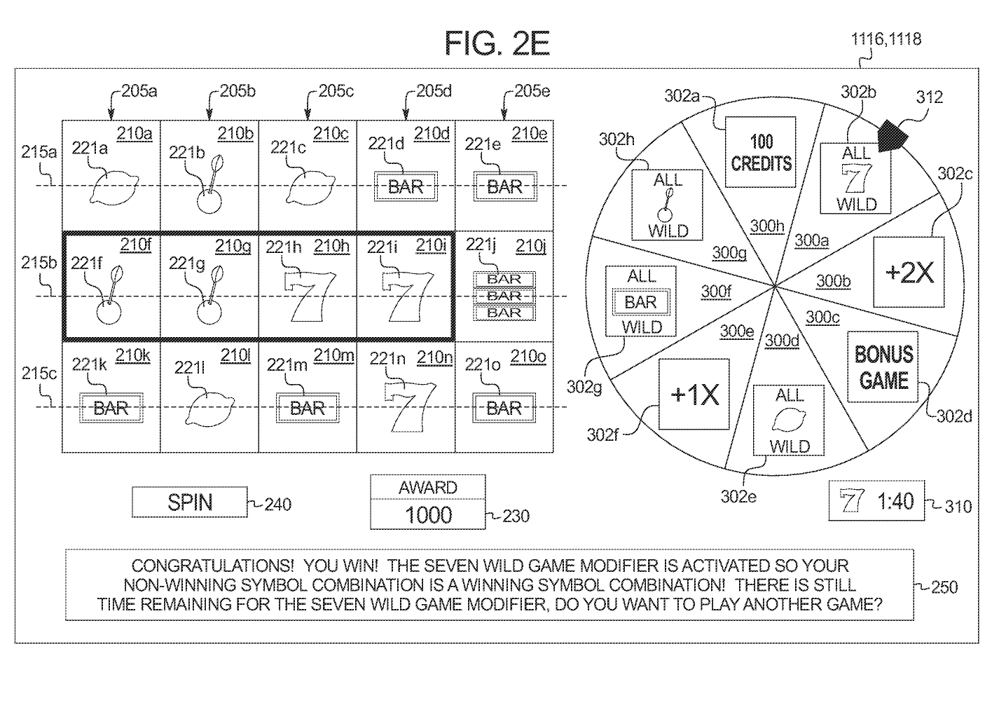

FIGS. 2A, 2B, 2C, 2D, and 2E illustrate screen shots of one embodiment of the gaming system of the present disclosure operating a primary game. In this embodiment, for the primary game, the gaming system enables the player to wager on and play the primary game.

Turning FIG. 2A, the gaming system displays, such as on a primary display device 1116 (described below), a primary game including a primary game symbol set. The display includes a plurality of symbol display areas or positions 210a, 210b, 210c, 210d, 210e, 210f, 210g, 210h, 210i, 210j, 210k, 2101, 210m, 210n, and 210o arranged in a grid or matrix. The gaming system also displays a plurality of reels 205a, 205b, 205c, 205d, and 205e, each of which is associated with a plurality of symbols the gaming system employs for the primary game. Each of the reels 205a, 205b, 205c, 205d, and 205e is associated with and configured to display symbols at a plurality of the symbol display areas. More specifically: (a) the reel 205a is associated with and configured to display symbols at symbol display areas 210a, 210f, and 210k; (b) the reel 205b is associated with and configured to display symbols at symbol display areas 210b, 210g, and 210l; (c) the reel 205c is associated with and configured to display symbols at symbol display areas 210c, 210h, and 210m; (d) the reel 205d is associated with and configured to display symbols at symbol display areas 210d, 210i, and 210n; and (e) the reel 205e is associated with and configured to display symbols at symbol display areas 210e, 210l, 210m, 210n, and 210o.

The gaming system displays a plurality of paylines 215a, 215b, and 215c, each of which is associated with a different plurality of the symbol display areas. More specifically: (a) payline 215a is associated with the symbol display areas 210a, 210b, 210c, 210d, and 210e; (b) payline 215b is associated with the symbol display areas 210f, 210g, 210h, 210i, and 210j; and (c) payline 215c is associated with the symbol display areas 210k, 2101, 210m, 210n, and 210o.

The gaming system also displays: (a) an award meter 230 that displays any awards won for the play of the primary game (in credit or currency form); (b) a SPIN button 240 that, when actuated by the player, causes the gaming system to initiate a play of the primary game; and (c) a message box 250 that displays a variety of messages or indications before, during, or after play of the primary game.

Turning to the game modifier generator 300, in this example, the game modifier generator is represented as a rotatable wheel. The game modifier generator includes a plurality of sections 300a, 300b, 300c, 300d, 300e, 300f, 300g, and 300h. In this example, each of the sections of the game modifier generator 300 is associated with one of a plurality of game modifiers, such as: (a) the “100 Credit” game modifier 302a displayed at section 300a; (b) the All Seven Symbols Wild game modifier 302b displayed at section 300b; (c) the +2× Multiplier game modifier 302c displayed at section 300c; (d) “Bonus Game” game modifier 302d displayed at section 300d; (e) the All Lemon Symbols Wild game modifier 302e displayed at section 300e; (f) the +1× Multiplier game modifier 302f displayed at section 300f; (g) the All Bar Symbols Wild game modifier 302g displayed at section 300g; and (h) the All Cherry Symbols Wild game modifier 302h displayed at section 300h.

In this example, certain game modifiers are automatically applied during a play of the primary game, such as for example, the “100 credit” modifier 302a displayed at section 300a. More specifically, if the game modifier generator randomly selects the “100 Credit” game modifier, the gaming system activates the “100 Credit” game modifier, and if the gaming system receives a wager to initiate a play of the primary game while the “100 Credit” game modifier is activated, for a play of the modified primary game (i.e., a play of the primary game wherein at least one game modifier is activated), the gaming system automatically applies one hundred credits to the player's award total. As will be described in greater detail below, in certain alternative embodiments the one hundred credits are conditionally applied based a designated symbol combination in the play of the modified primary game.

In this example, certain other game modifiers modify one of the symbols from the primary game symbol set. More specifically, in this example, the game modifiers associated with a symbol from the primary game symbol set are: (a) the All Seven Symbols Wild game modifier 302b displayed at section 300b; (b) the All Lemon Symbols Wild game modifier 302e displayed at section 300e; (c) the All Bar Symbols Wild game modifier 302g displayed at section 300g; and (d) the All Cherry Symbols Wild game modifier 302h displayed at section 300h. Each of the Seven, Lemon, Bar, and Cherry are symbols from the primary game symbol set. In this example, if a game modifier associated with a symbol from the primary game is randomly selected and activated, for a play of the modified primary (i.e., a play of the primary game wherein at least one game modifier is activated) game that symbol functions as a WILD symbol for the determined activation duration. In various embodiments, each generated wild symbol functions as or otherwise changes to a different symbol, such as a symbol that causes a non-winning symbol combination to become a winning symbol combination. In one such embodiment, if the gaming system generates a wild symbol at a symbol display position, the gaming system causes that wild symbol to function as a symbol that completes a winning symbol combination (e.g., the highest winning symbol combination) along one of the paylines. In another such embodiment, if the gaming system generates a wild symbol at a symbol display position, the gaming system causes the wild symbol to substitute for one of the symbols indicated on the same payline as the wild symbol. In another such embodiment, if the gaming system generates a wild symbol at a symbol display position, the gaming system causes the wild symbol to match or substitute for a designated symbol on a payline, such as a jackpot symbol or the symbol associated with the largest award in the game.

The remaining game modifiers in this example are associated with a feature that is temporarily available and is awarded to the player if the gaming system generates a designated symbol combination in a play of the modified primary game. In this example, the game modifiers associated with a feature are: (a) the +2× Multiplier game modifier 302c displayed at section 300c; (b) the “Bonus Game” game modifier 302d displayed at section 300d; and (c) the +1× Multiplier game modifier 302f displayed at section 300f. In this example, if a game modifier associated with a feature is randomly selected and activated, for a play of the modified primary game, the feature associated with the selected game modifier is available for one or more plays of the game for the determined activation duration. If the gaming system generates a designated symbol combination, the gaming system provides the feature associated with the selected game modifier. The designated symbol combination is a symbol combination that triggers the feature associated with the selected game modifier. For example, in this embodiment, when the +2× Multiplier game modifier is activated and the player initiates a play of the primary game, for the play of the modified primary game, if the gaming system generates a designated symbol combination, the gaming system provides a 3× multiplier to any award for the designated symbol combination. In this example, all winning symbol combinations are designated symbol combinations.

Turning back to FIG. 2A, which illustrates a screen shot of the gaming system display prior to initiation of a play of the primary game. The gaming system displays the following message in the message box 250: “WHEN WILL THE WHEEL SPIN? WHICH GAME MODIFIER WILL BE ACTIVATED AND FOR HOW LONG? PLACE A WAGER WHILE YOU WAIT!”

Turning to FIG. 2B, a game modifier triggering event randomly occurs. It should be appreciated that the gaming system has not received a wager to initiate a play of the primary game. As explained above, this game modifier triggering event occurs randomly independent of any displayed event of any play of any game.

Upon the occurrence of a game modifier triggering event, the gaming system activates the game modifier generator 300. In this example, the game modifier generator 300 is a wheel and when the game modifier generator 300 is activated, the wheel spins, as shown in FIG. 2B, to randomly select a game modifier. In this example, each section of the game modifier generator wheel 300 is associated with a game modifier. Thus, the gaming system causes the game modifier generator to randomly select a section of the game modifier generator and the game modifier associated with that section is selected. The gaming system displays the following message in the message box 250: “THE WHEEL IS RANDOMLY SPINNING! LET'S SEE WHICH GAME MODIFIER WILL BE SELECTED AND HOW LONG IT WILL BE ACTIVATED!”

Turning to FIG. 2C, the gaming system displays the game modifier generator after the game modifier triggering event has randomly occurred. An indicator 312 indicates that the All Seven Symbols Wild game modifier is the selected game modifier. Upon causing the game modifier generator to randomly select the game modifier, the gaming system determines an activation duration for the game modifier. In this example, the activation duration for all game modifiers is predetermined to be two minutes. Once the gaming system determines the activation duration for the game modifier, the gaming system activates the game modifier for the determined activation duration. In this example, the gaming system indicates that a game modifier is activated by displaying an icon associated with the activated game modifier and displaying the remaining activation duration on a game modifier duration display 310. In this example, the game modifier duration display 310 is also referred to as the game modifier clock. As shown in FIG. 20, the game modifier duration display 310 indicates that the All Seven Symbols Wild game modifier is activated for two minutes. The gaming system displays the following message in the message box 250: “THE SEVEN WILD GAME MODIFIER IS SELECTED! THAT INDICATES THAT THE SEVEN SYMBOL IS WILD FOR THE TIME REMAINING ON THE GAME MODIFIER CLOCK! HURRY AND PRESS ‘SPIN’ TO PLACE A WAGER ON A PLAY OF THE SLOT GAME AND SPIN THE REELS WHILE THE SEVEN IS WILD!”

Turning to FIG. 2D, as seen on the game modifier duration display 310, ten seconds have elapsed and one minute and fifty seconds remain for the All Seven Symbols Wild game modifier activation duration. The gaming system receives an actuation of the SPIN button 240 and initiates a play of the primary game. In this example, the player wagered on all three paylines 215a, 215b, and 215c. Once a play of the game is initiated, the gaming system determines that the All Seven Symbols Wild game modifier is activated, and the gaming system modifies the relevant parameter for a play of a modified primary game (i.e., wherein at least one game modifier is activated). In this example, the relevant parameter is the Seven Symbol in the primary game symbol set. Specifically, in the determination of the game outcome for the play of the modified primary game, the Seven symbol functions as a wild in any symbol combination that includes a Seven symbol. The gaming system displays the following message in the message box 250: “PLEASE WAIT WHILE THE REELS SPIN.”

As illustrated in FIG. 2E, the gaming system stops reels 205a, 205b, 205c, 205d, and 205e such that: (a) Lemon symbol 221a is displayed at symbol display area 210a, (b) Cherry symbol 221b is displayed at symbol display area 210b, (c) Lemon symbol 221c is displayed at symbol display area 210c, (d) Bar symbol 221d is displayed at symbol display area 210d, (e) Bar symbol 221e is displayed at symbol display area 210e, (f) Cherry symbol 221f is displayed at symbol display area 210f, (g) Cherry symbol 221g is displayed at symbol display area 210g, (h) Seven symbol 221h is displayed at symbol display area 210h, (i) Seven symbol 221i is displayed at symbol display area 210i, (j) Triple Bar symbol 221j is displayed at the symbol display area 210j, (k) Bar symbol 221k is displayed at the symbol display area 210k, (l) Lemon symbol 221l is displayed at the symbol display area 210l, (m) Bar symbol 221m is displayed at the symbol display area 210m, (n) Seven symbol 221n is displayed at the symbol display area 210n, and (o) Bar symbol 2210 is displayed at the symbol display area 210o.

The gaming system determines the game outcome and any awards associated with the determined game outcome. In this example, the symbol combination along payline 215b, which would otherwise be a non-winning combination in an unmodified play of the primary game, is a winning symbol combination. The gaming system displays and provides the award associated with the determined winning symbol combination along payline 215b. The gaming system displays the following message in the message box 250: “CONGRATULATIONS! YOU WIN! THE SEVEN WILD GAME MODIFIER IS ACTIVATED SO YOUR NON-WINNING SYMBOL COMBINATION IS A WINNING SYMBOL COMBINATION! THERE IS STILL TIME REMAINING FOR THE SEVEN WILD GAME MODIFIER, DO YOU WANT TO PLAY ANOTHER GAME?”

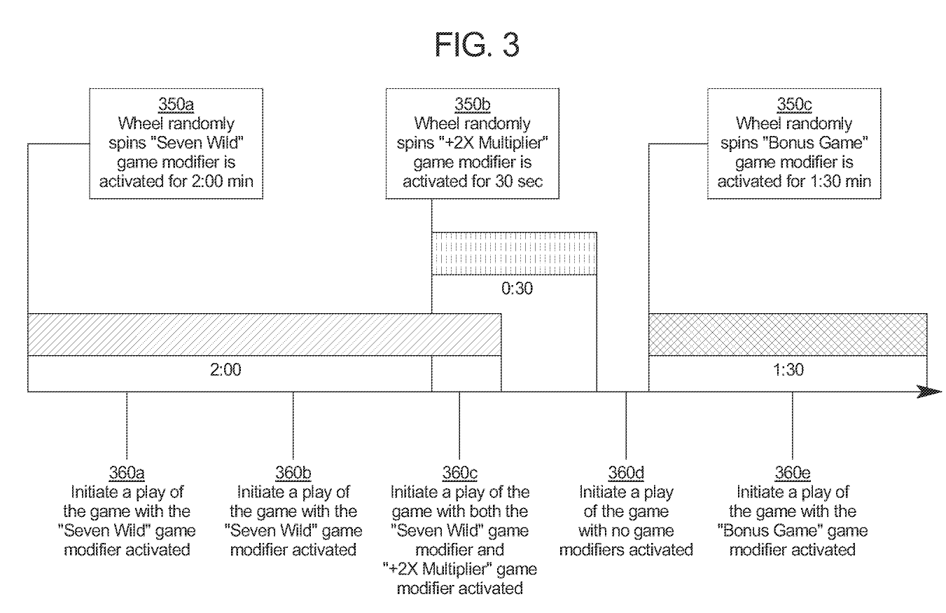

Turning to FIG. 3, which illustrates an example timeline depicting a plurality of plays of the primary game of one embodiment of the present disclosure. The bottom of the time line depicts each instance that the player initiates a play of the primary game as indicated by 360a, 360b, 360c, 360d, and 360e. The top of the timeline depicts each instance that the game modifier triggering event randomly occurs, as indicated by 350a, 352a, and 354a. The top of the timeline also depicts the activation duration for any activated game modifiers. As illustrated, the start of the activation duration for each activated game modifier is indicated by 350a, 352a, and 354a, and the end of the activation duration for each activated game modifier is indicated by 350b, 352b, and 354b respectively. As should be appreciated from the timeline, the game modifier triggering event occurs randomly and independently of any initiation of any play of the primary game and independent of any displayed event in any play of the primary game.

In this example, each instance that the game modifier triggering event randomly occurs, the game modifier generator is activated and the game modifier generator randomly selects a game modifier. Once a game modifier is selected, the gaming system determines an activation duration for the selected game modifier. The first game modifier triggering event is indicated by 350a. The game modifier generator is activated and the wheel spins. The game modifier generator selects the All Seven Symbols Wild game modifier, and the gaming system determines an activation duration of two minutes as indicated in the timeline. Accordingly, any game played during the next two minutes will employ the modified feature of all Seven symbols functioning as wild symbols.

At the bottom of the time line, the next two events 360a and 360b indicate two different instances that the gaming system receives a wager to initiate a play of the primary game. For each instance, 360a and 360b, the gaming system determines that the All Seven Symbols Wild game modifier is activated, and thus initiates a play of a modified primary game (i.e. a play of a primary game wherein at least one game modifier is activated).

The next event on the timeline is the second game modifier triggering event 352a. Once the game modifier triggering event randomly occurs, the wheel spins to select the next game modifier which is the +2× Multiplier game modifier. The gaming system determines an activation duration of thirty seconds. Accordingly, any game played during the next thirty seconds will employ the modified feature of a +2× multiplier.

It should be appreciated that in this example, two game modifiers are activated at this time. Thus, for each play of a modified primary game initiated while both game modifiers are activated, the gaming system evaluates all Seven symbols as a wild symbol and provides a 2× multiplier for the award associated with any winning symbol combination. Thus, for the duration that both game modifiers are activated, the gaming system provides both an increased opportunity generate a winning symbol combination and increased awards for any generated winning symbol combinations.

Additionally, it should be appreciated that both game modifiers have a different determined activation duration. Thus, the gaming system provides different game modifiers for different periods of time. Such a configuration provides that different plays of a game may employ different features based on when such plays are initiated and which modifiers have previously been selected, and how much of the activation duration of each selected game modifier remains,

The next event on the timeline is the end of the All Seven Symbols Wild game modifier activation duration, indicated by 350b. The +2× Multiplier game modifier is no longer activated after the point in time represented by 352b on the timeline. The next event on the timeline is another instance of a wager placed by the player to initiate a play of the primary game at 360d. The gaming system determines that no game modifiers are activated and thus initiates a play of the primary game without any modifications.

The next event on the timeline is the random game modifier triggering event at 354a. The wheel spins to select the ‘Bonus Game’ game modifier and the gaming system determines an activation duration of one minute and thirty seconds for the “Bonus Game” game modifier. Accordingly, any game played during the next one minute and thirty seconds will employ the modified feature of a Bonus Game symbol. The next instance that the gaming system receives a wager to initiate a play of the primary game is at 360e. The gaming system determines that the Bonus Game modifier is activated and thus initiates a play of the modified primary game. For the play of the modified primary game, if the gaming system generates a designated symbol combination along a wagered-on payline, the gaming system will initiate a bonus game. That is, in addition to any determined game outcome and any award associated with the determined game outcome, the gaming system enables the player to play a bonus game.

As illustrated in the timeline, the end of the activation duration for the “Bonus Game” game modifier is not shown. It should be appreciated from the example timeline that each of the selected game modifiers are activated for a different activation duration, and each game modifier modified a different parameter of the primary game. It should also be appreciated that in this example the gaming system provided overlapping game modifiers such that for certain plays of the modified primary game, the gaming system provided multiple game modifiers to the player.

### Game Modifier Generator

In various alternative embodiments of the present disclosure, the frequency and the timing of the randomly occurring game modifier triggering event is different from the embodiments described above. In the embodiments described above, the frequency of the triggering event is random. In certain alternative embodiments, the frequency of the game modifier triggering event is based on the wager placed by player. More specifically, the greater the wager placed by the player, the greater the frequency of the game modifier triggering events. In certain alternative embodiments, the possibility of multiple game modifiers being simultaneously activated, as in the example described above with respect to FIG. 3, depends on the wager amount. For a single high enough wager, it could be possible to have more than one game modifier activated at the same time.

Additionally, in the embodiment described above, the game modifier triggering events randomly occur before, during, or after a play of the primary game. In different embodiments, a game modifier triggering event occurs based on an outcome associated with one or more plays of any primary games. In one embodiment, such determinations are symbol driven based on the generation of one or more designated symbols or symbol combinations. In various embodiments, a generation of a designated symbol (or sub-symbol) or a designated set of symbols (or sub-symbols) over one or more plays of a primary game causes such conditions to be satisfied and/or one or more of such events to occur.

In different embodiments, the gaming system does not provide any apparent reasons to the players for an occurrence of a game modifier triggering event. In these embodiments, such determinations are not triggered by an event in a primary game or based specifically on any of the plays of any primary games. That is, these events occur without any explanation or alternatively with simple explanations.

In one such embodiment, a game modifier triggering event, occurs based on an amount of coin-in. In this embodiment, the gaming system determines if an amount of coin-in reaches or exceeds a designated amount of coin-in (i.e., a threshold coin-in amount). Upon the amount of coin-in wagered reaching or exceeding the threshold coin-in amount, the gaming system causes one or more of such events or conditions to occur. In another such embodiment, a game modifier triggering event occurs based on an amount of virtual currency-in. In this embodiment, the gaming system determines if an amount of virtual currency-in wagered reaches or exceeds a designated amount of virtual currency-in (i.e., a threshold virtual currency-in amount). Upon the amount of virtual currency-in wagered reaching or exceeding the threshold virtual currency-in amount, the gaming system causes one or more of such events or conditions to occur. In different embodiments, the threshold coin-in amount and/or the threshold virtual currency-in amount is predetermined, randomly determined, determined based on a player's status (such as determined through a player tracking system), determined based on a generated symbol or symbol combination, determined based on a random determination by the central controller, determined based on a random determination at the gaming device, determined based on one or more side wagers placed, determined based on the player's primary game wager, determined based on time (such as the time of day) or determined based on any other suitable method or criteria.

In one such embodiment, a game modifier triggering event, occurs based on an amount of coin-out. In this embodiment, the gaming system determines if an amount of coin-out reaches or exceeds a designated amount of coin-out (i.e., a threshold coin-out amount). Upon the amount of coin-out reaching or exceeding the threshold coin-out amount, the gaming system causes one or more of such events or conditions to occur. In another such embodiment, a game modifier triggering event occurs based on an amount of virtual currency-out. In this embodiment, the gaming system determines if an amount of virtual currency-out reaches or exceeds a designated amount of virtual currency-out (i.e., a threshold virtual currency-out amount). Upon the amount of virtual currency-out reaching or exceeding the threshold virtual currency-out amount, the gaming system causes one or more of such events or conditions to occur. In different embodiments, the threshold coin-out amount and/or the threshold virtual currency-out amount is predetermined, randomly determined, determined based on a player's status (such as determined through a player tracking system), determined based on a generated symbol or symbol combination, determined based on a random determination by the central controller, determined based on a random determination at the gaming device, determined based on one or more side wagers placed, determined based on the player's primary game wager, determined based on time (such as the time of day) or determined based on any other suitable method or criteria.

In different embodiments, a game modifier triggering event, occurs based on a predefined variable reaching a defined parameter threshold. For example, when the 500,000th player has played an electronic gaming machine (ascertained from a player tracking system), one or more of such events or conditions occur. In different embodiments, the predefined parameter thresholds include a length of time, a length of time after a certain dollar amount is hit, a wager level threshold for a specific device (which electronic gaming machine is the first to contribute $250,000), a number of electronic gaming machines active, or any other parameter that defines a suitable threshold.

In different embodiments, a game modifier triggering event, occurs based on a quantity of games played. In this embodiment, a quantity of games played is set for when one or more of such events or conditions will occur. In one embodiment, such a set quantity of games played is based on historic data

In different embodiments, a game modifier triggering event, occurs based on time. In this embodiment, a time is set for when one or more of such events or conditions will occur. In one embodiment, such a set time is based on historic data.

In different embodiments, a game modifier triggering event, occurs based upon gaming system operator defined player eligibility parameters stored on a player tracking system (such as via player tracking card or other suitable manner). In this embodiment, the parameters for eligibility are defined by the gaming system operator based on any suitable criterion. In one embodiment, the gaming system recognizes the player's identification (via the player tracking system) when the player inserts or otherwise associates their player tracking card in the electronic gaming machine. The gaming system determines the player tracking level of the player and if the current player tracking level defined by the gaming system operator is eligible for one or more of such events or conditions. In one embodiment, the gaming system operator defines minimum bet levels required for such events or conditions to occur based on the player's card level.

In different embodiments, a game modifier triggering event, occurs based on a system determination, including one or more random selections by the central controller. In one embodiment, as described above, the gaming system tracks all active electronic gaming machines and the wagers they placed. In one such embodiment, based on the electronic gaming machine's state as well as one or more wager pools associated with the electronic gaming machine, the gaming system determines whether to one or more of such events or conditions will occur. In one such embodiment, the player who consistently places a higher wager is more likely to be associated with an occurrence of one or more of such events or conditions than a player who consistently places a minimum wager. It should be appreciated that the criteria for determining whether a player is in active status or inactive status for determining if one or more of such events occur may the same as, substantially the same as, or different than the criteria for determining whether a player is in active status or inactive status for another one of such events to occur.

In different embodiments, a game modifier triggering event, occurs based on a determination of if any numbers allotted to an electronic gaming machine match a randomly selected number. In this embodiment, upon or prior to each play of each electronic gaming machine, an electronic gaming machine selects a random number from a range of numbers and during each primary game, the electronic gaming machine allocates the first N numbers in the range, where N is the number of credits bet by the player in that primary game. At the end of the primary game, the randomly selected number is compared with the numbers allocated to the player and if a match occurs, one or more of such events or conditions occur. It should be appreciated that any suitable manner of causing a game modifier triggering event to occur may be implemented in accordance with the gaming system and method disclosed herein.

It should be appreciated that one or more of the above-described triggers pertaining to one or more of such triggering events occurring may be combined in one or more different embodiments.

In certain alternative embodiments, the game modifier triggering events do not occur before or after a play of the game. More specifically, in an example of such an embodiment, the game modifier triggering event occurs during an initiated play of the game. In certain embodiments, if a game modifier is activated during the play of the game, it remains activated for the determined duration after the play of the game regardless of whether another play of a game is subsequently initiated.

In certain alternative embodiments, the game modifier generator is represented by a rotatable wheel and the wheel includes a plurality of sections. In certain alternative embodiments, each section of the wheel is associated with a game modifier. In certain other alternative embodiments, a plurality of the plurality of sections is associated with a game modifier. That is, certain sections of the wheel are not associated with a game modifier. Thus, in an example of such an embodiment, the occurrence of a game modifier triggering event does not necessarily indicate that a game modifier will be selected. In the example, if the selected section of the game modifier generator is not associated with a game modifier, the gaming system does not activate any game modifier. In various alternative embodiments, the game modifier generator is a shape other than a wheel. In certain of these embodiments, the game modifier generator includes a plurality of sections at least some of which are associated with a game modifier.

### Game Modifier Selection and Activation

In various alternative embodiments, the selection of the game modifier is different from the embodiments described above with respect to FIGS. 2A to 2E, and 3. In certain alternative embodiments, the selection of each game modifier is not random, but rather is predetermined. More specifically, the occurrence of the game modifier triggering event is random but once activated, the selection of the game modifier is predetermined. In one example, it may be predetermined that for the first random game modifier triggering event, one of a first set of game modifiers will be selected. Similarly, for a second random game modifier triggering event one of a second set of game modifiers will be selected. In certain alternative embodiments, the game modifier selection is wager-based.

Once selected, the gaming system determines the duration of activation for each game modifier. This duration pertains to a period of time and/or to a quantity of subsequent plays of the game. In various alternative embodiments, the gaming system determines the duration for activation of the game modifier in a plurality of ways. In certain alternative embodiments, the duration is randomly determined for each game modifier. In certain alternative embodiments, the duration for activation is predetermined for each game modifier. In certain alternative embodiments, the duration for each game modifier is the same and in certain other alternative embodiments, the duration for at least some of the game modifiers is different. The duration may be determined based on the wager placed by the player. For example, the greater the wager the longer the duration for activation for the game modifiers.

Once the duration for activation is determined, the gaming system activates the game modifier. In the embodiment described above, once the game modifier is activated, a game modifier duration clock is displayed on the gaming display indicating the remaining time for the game modifier duration. In various alternative embodiments, an icon associated with the selected game modifier is displayed on the gaming display for the duration that the game modifier is activated. It should be appreciated that in certain alternative embodiments, the gaming system does not display the remaining time for each activated game modifier and thus does not indicate how long the game modifier remains activated. In one example of the alternative embodiment, the gaming system displays an icon associated with the activated game modifier for the duration, and removes the display of the icon associated with the game modifier when it is no longer activated.

In certain embodiments, the gaming system ends the activation duration for game modifiers immediately after the gaming system provides the player the feature associated with the game modifier regardless of how much of the activation duration is remaining. In certain other alternative embodiments, the gaming system provides the feature associated with the game modifier for the entire activation duration regardless of whether or not the player has already received the feature.

### Game Modifiers and Modified Plays of the Game

Upon receiving a wager, the gaming system initiates a play of the primary game. If there are any activated game modifiers, the gaming system modifies the relevant parameters of the primary game based on each of the activated game modifiers. In various alternative embodiments of the present disclosure, the gaming system modifies the primary game in a plurality of different ways.

It should be appreciated that the game modifiers in the embodiments described above with respect to FIGS. 2A to 2E, and 3, are exemplary and intended to be non-limiting. In the embodiment described above, the game modifiers altered certain parameters of the game by: (1) adding a credit amount to the award for a determined outcome, (2) changing a base game symbol to function as a wad, and (3) adding features associated with designated symbol combinations. In certain other alternative embodiments, the game modifiers modify different parameters of the game including, but not limited to, the available award for certain symbol combinations, the available time for a play of a game, the available time for an activation duration, and the availability of a bonus or secondary game. For example, a game modifier is associated with a duration that is added to an activated game modifier.

In certain embodiments, game modifiers are associated with a symbol from the base or primary game symbol set. In these alternative embodiments certain game modifiers modify the primary game symbol set by temporarily altering certain symbols from the primary or base game symbol set. In certain embodiments, a game modifier associated with a base or primary game symbol modifies the award associated with any winning symbol combination including the base or primary game symbol associated with the selected game modifier. In certain other alternative embodiments, a game modifier associated with a symbol from the base or primary game symbol set is associated with a bonus game. For example, for an activated game modifier associated with a base or primary game symbol, the gaming system modifies the primary game by providing a bonus game if the base or primary symbol is included in a winning symbol combination. In another alternative embodiment, the symbols from the primary game symbol set are associated with various other features including but not limited to credits, an additional play of the game, an additional bonus game and other award modifiers. It should be appreciated that the example game modifiers described herein are exemplary and are not intended to be limiting.

In certain alternative embodiments, certain game modifiers are unrelated to the symbols from the primary game symbol set, and are associated with the same or different feature as those described above. In various alternative embodiments, game modifiers modify the primary game symbol set by temporarily adding a symbol to the primary game symbol set wherein the added symbol is associated with a feature. Some examples of features include, but are not limited to: award modifiers, bonus game triggering events, or time added to an activation duration for a game modifier, or other similar features.

As discussed above, in certain embodiments, if a game modifier is activated, the gaming system modifies one or more attributes or features of one or more plays of the games. In different embodiments, the gaming system selects such attribute(s) or feature(s) from the group of features including, but not limited to:
a book-end wild symbols feature;
ii. a stacked wild symbols feature;
iii. an expanding wild symbols feature;
iv. a wild reel feature;
v. a retrigger symbol feature;
vi. an anti-terminator symbol feature;
vii. a locking reel feature;
viii. a locking symbol display position feature;
ix. a modification of a paytable utilized for a play of a game;
x. an application of a modifier, such as a multiplier or an additional quantity of credits, to one or more awards of a paytable utilized for a play of a game;
xi. a modification of an average expected payback percentage of a play of a game;
xii. a modification of an average expected payout of a play of a game;
xiii. a modification of one or more awards available;
xiv. a modification of a range of awards available;
xv. a modification of a type of awards available;
xvi. a modification of one or more progressive awards;
xvii. a modification of which progressive awards are available to be won;

xviii. a modification of one or more modifiers, such as multipliers, available;
xix. a modification of an activation of a reel (or a designated reel);
xx. a modification of an activation of a plurality of reels;
xxi. a modification of a generated outcome (or a designated generated outcome);
xxii. a modification of a generated outcome (or a designated generated outcome) associated with an award over a designated value;
xxiii. a modification of a generated outcome (or a designated generated outcome) on a designated payline;
xxiv. a modification of a generated outcome (or a designated generated outcome) in a scatter configuration;
xxv. a modification of a winning way to win (or a designated winning way to win);
xxvi. a modification of a designated symbol or symbol combination;
xxvii. a modification of a generation of a designated symbol or symbol combination on a designated payline;
xxviii. a quantity of paylines to activate;
xxix. which paylines to activate;
xxx. a quantity of ways to win;
xxxi. which ways to win;
xxxii. a modification of a generation of a designated symbol or symbol combination in a scatter configuration;
xxxiii. a modification of an activation of a secondary or bonus display (such as an award generator);
xxxiv. a modification of a quantity of activations of a secondary or bonus display (e.g., a modification of a quantity of spins of an award generator);
xxxv. a modification of a quantity of sections of a secondary or bonus display (e.g., a modification of a quantity of sections of an award generator);
xxxvi. a modification of one or more awards of a secondary or bonus display;
xxxvii. a modification of an activation of a community award generator;
xxxviii. a modification of a quantity of activations of a community award generator;
xxxix, a modification of a quantity of sections of a community award generator;
xl. a modification of one or more awards of a community award generator;
xli. a modification of a quantity of picks in a selection game;
xlii. a modification of a quantity of offers in an offer and acceptance game;
xliii. a modification of a quantity of moves in a trail game;
xliv. a modification of an amount of free spins provided;
xlv, a modification of a game terminating or ending condition;
xlvi. a modification of how one or more aspects of one or more games (e.g., colors, speeds, sound) are displayed to a player; and
xlvii. a modification of any game play feature associated with any play of any game disclosed herein.

In certain embodiments, the game modifier is associated with a secondary or bonus game. In certain embodiments, the gaming system selects a secondary or bonus game to play from the group of secondary games including, but not limited to:

a play of any suitable slot game;
a play of any suitable free spins or free game activations;
iii. a play of any suitable wheel game;
iv. a play of any suitable card game;
v. a play of any suitable offer and acceptance game;
vi. a play of any suitable award ladder game;
vii. a play of any suitable puzzle-type game;
viii. a play of any suitable persistence game;
ix. a play of any suitable selection game;
x. a play of any suitable cascading symbols game;
xi. a play of any suitable ways to win game;
xii. a play of any suitable scatter pay game;
xiii. a play of any suitable coin-pusher game;
xiv. a play of any suitable elimination game;
xv. a play of any suitable stacked wilds game;
xvi. a play of any suitable trail game;
xvii. a play of any suitable bingo game;
xviii. a play of any suitable video scratch-off game;
xix. a play of any suitable pick-until-complete game;
xx. a play of any suitable shooting simulation game;
xxi. a play of any suitable racing game;
xxii. a play of any suitable promotional game;
xxiii. a play of any suitable high-low game;
xxiv. a play of any suitable lottery game;
xxv. a play of any suitable number selection game;
xxvi. a play of any suitable dice game;
xxvii. a play of any suitable skill game;
xxviii. a play of any suitable auction game;
xxix. a play of any suitable reverse-auction game;
xxx. a play of any suitable group game;
xxxi. a play of any suitable game in a service window;
xxxii. a play of any suitable game on a mobile device; and/or
xxxiii. a play of any other suitable type of game.

In various alternative embodiments, the gaming system automatically provides the player the feature associated with the selected game modifier. For example, in certain embodiments, if the gaming system activates a game modifier associated with a credit value, that credit value is instantly awarded to the player for a play of a game initiated during the determined duration. In another example, once a game modifier associated with a feature or a bonus game is activated, for a play of the modified primary game, the gaming system automatically provides the feature for any winning symbol combination. For example, if a +2× Multiplier game modifier is activated, the gaming system provides the +2× Multiplier for any award associated with a winning symbol combination during any play of the modified primary game during the activation duration. In another example, if a “Bonus Game” game modifier is activated, the gaming system automatically provides a Bonus Game upon the initiation of a play of a modified primary game.

In other alternative embodiments, gaming system provides the player the game modifier feature if a designated symbol combination is generated. For example, in certain alternative embodiments, a credit value associated with an activated game modifier is available for the player for the determined activation duration. In this example, the gaming system provides the credit value to the player if the gaming system generates a designated winning symbol combination for a play of the game during the determined activation duration. In certain alternative embodiments, the designated symbol combination is predetermined. In certain other alternative embodiments, the designated symbol combination is randomly determined.

It should be appreciated that the awards may be any suitable awards such as, but not limited to: (1) monetary credits or currency; (2) non-monetary credits or currency; (3) a modifier (such as a multiplier) used to modify one or more awards; (4) one or more free plays of a game (such as one or more free spins of a slot game); (5) one or more plays of one or more bonus games (such as a free spin of an award wheel); (6) one or more lottery based awards (such as one or more lottery or drawing tickets); (7) a wager match for one or more plays of the a wagering game; (8) an increase in an average expected payback percentage of a bonus game and/or an average expected payback percentage of a primary wagering game for one or more plays; (9) one or more comps (such as a free dinner or a free night's stay at a hotel); (10) one or more bonus or promotional credits usable for online play; (11) one or more player tracking points; (12) a multiplier for player tracking points or credits; (13) an increase in a membership or player tracking level; (14) one or more coupons or promotions usable within a gaming establishment and/or outside of the gaming establishment (e.g., a 20% off coupon for use at a retail store or a promotional code providing a deposit match for use in association with an online casino); (15) an access code usable to unlock content on the Internet; (16) a progressive jackpot or other progressive award; (17) a high value product or service (such as a car); and/or (18) a low value product or service (such as a teddy bear).

In one embodiment, the gaming system causes at least one display device of at least one electronic gaming machine to display the game. In one such embodiment, the gaming system causes a supplemental display device, such as a top box, of an electronic gaming machine to display the game. In another such embodiment, the gaming system causes the game to be displayed in one or more service windows or pop-up screens. In another embodiment, in addition or in alternative to each electronic gaming machine displaying the game, one or more players, the gaming system causes one or more community or overhead display devices to display part or all of the game to one or more other players or bystanders either at a gaming establishment or viewing over a network, such as the internet. In another embodiment, in addition or in alternative to each electronic gaming machine displaying the game, the gaming system causes one or more internet sites to each display the game such that a player is enabled to log on from a personal web browser. In another such embodiment, the gaming system enables the player to play one or more games on one device while viewing the game from another device, such as a desktop or laptop computer.

It should be appreciated that in different embodiments, one or more of:
i. whether to trigger a game modifier triggering event;
ii. when to trigger a game modifier triggering event;
ii. the quantity of game modifiers to select;
iv. which game modifiers to select;
v. the activation duration for each selected game modifier;
vi. which parameters of the game to modify;
vii. the quantity of game modifiers available to select from;
viii. the frequency of the game modifier triggering event;
ix. the quantity of game modifiers to activate simultaneously; and/or
x. any determination disclosed herein;
   is/are predetermined, randomly determined, randomly determined based on one or more weighted percentages, determined based on a generated symbol or symbol combination, determined independent of a generated symbol or symbol combination, determined based on a random determination by the central controller, determined independent of a random determination by the central controller, determined based on a random determination at the gaming system, determined independent of a random determination at the gaming system, determined based on at least one play of at least one game, determined independent of at least one play of at least one game, determined based on a player's selection or input, determined independent of a player's selection or input, determined based on one or more side wagers placed, determined independent of one or more side wagers placed, determined based on the player's primary game wager, determined independent of the player's primary game wager, determined based on time (such as the time of day), determined independent of time (such as the time of day), determined based on an amount of coin-in accumulated in one or more pools, determined independent of an amount of coin-in accumulated in one or more pools, determined based on a status of the player (Le., a player tracking status), determined independent of a status of the player (Le., a player tracking status), determined based on one or more other determinations disclosed herein, determined independent of any other determination disclosed herein or determined based on any other suitable method or criteria.

### Gaming Systems

It should be appreciated that the above-described embodiments of the present disclosure may be implemented in accordance with or in conjunction with one or more of a variety of different types of gaming systems, such as, but not limited to, those described below.

The present disclosure contemplates a variety of different gaming systems each having one or more of a plurality of different features, attributes, or characteristics. It should be appreciated that a “gaming system” as used herein refers to various configurations of: (a) one or more central servers, central controllers, or remote hosts; (b) one or more EGMs; and/or (C) one or more personal gaming devices, such as desktop computers, laptop computers, tablet computers or computing devices, personal digital assistants (PDAs), mobile telephones such as smart phones, and other mobile computing devices.

Thus, in various embodiments, the gaming system of the present disclosure includes: (a) one or more EGMs in combination with one or more central servers, central controllers, or remote hosts; (b) one or more personal gaming devices in combination with one or more central servers, central controllers, or remote hosts; (c) one or more personal gaming devices in combination with one or more EGMs; (d) one or more personal gaming devices, one or more EGMs, and one or more central servers, central controllers, or remote hosts in combination with one another; (e) a single EGM; (f) a plurality of EGMs in combination with one another; (g) a single personal gaming device; (h) a plurality of personal gaming devices in combination with one another; (i) a single central server, central controller, or remote host; and/or (j) a plurality of central servers, central controllers, or remote hosts in combination with one another.

For brevity and clarity, each EGM and each personal gaming device of the present disclosure is collectively referred to herein as an “EGM.” Additionally, for brevity and clarity, unless specifically stated otherwise, “EGM” as used herein represents one EGM or a plurality of EGMs, and “central server, central controller, or remote host” as used herein represents one central server, central controller, or remote host or a plurality of central servers, central controllers, or remote hosts.

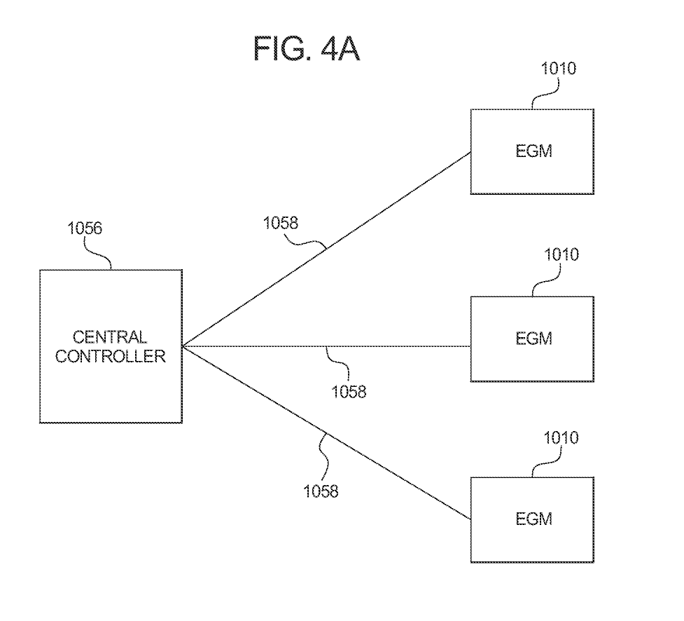

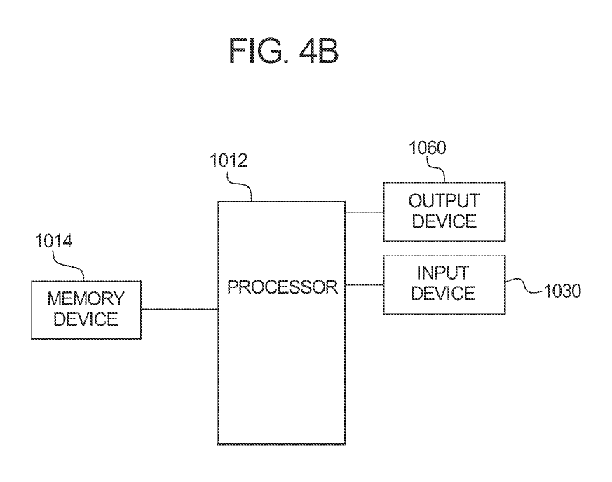

As noted above, in various embodiments, the gaming system includes an EGM in combination with a central server, central controller, or remote host. In such embodiments, the EGM is configured to communicate with the central server, central controller, or remote host through a data network or remote communication link. In certain such embodiments, the EGM is configured to communicate with another EGM through the same data network or remote communication link or through a different data network or remote communication link. For example, the gaming system illustrated in FIG. 4A includes a plurality of EGMs 1010 that are each configured to communicate with a central server, central controller, or remote host 1056 through a data network 1058.

In certain embodiments in which the gaming system includes an EGM in combination with a central server, central controller, or remote host, the central server, central controller, or remote host is any suitable computing device (such as a server) that includes at least one processor and at least one memory device or storage device. As further described below, the EGM includes at least one EGM processor configured to transmit and receive data or signals representing events, messages, commands, or any other suitable information between the EGM and the central server, central controller, or remote host. The at least one processor of that EGM is configured to execute the events, messages, or commands represented by such data or signals in conjunction with the operation of the EGM. Moreover, the at least one processor of the central server, central controller, or remote host is configured to transmit and receive data or signals representing events, messages, commands, or any other suitable information between the central server, central controller, or remote host and the EGM. The at least one processor of the central server, central controller, or remote host is configured to execute the events, messages, or commands represented by such data or signals in conjunction with the operation of the central server, central controller, or remote host. It should be appreciated that one, more, or each of the functions of the central server, central controller, or remote host may be performed by the at least one processor of the EGM. It should be further appreciated that one, more, or each of the functions of the at least one processor of the EGM may be performed by the at least one processor of the central server, central controller, or remote host.

In certain such embodiments, computerized instructions for controlling any games (such as any primary or base games and/or any secondary or bonus games) displayed by the EGM are executed by the central server, central controller, or remote host. In such “thin client” embodiments, the central server, central controller, or remote host remotely controls any games (or other suitable interfaces) displayed by the EGM, and the EGM is utilized to display such games (or suitable interfaces) and to receive one or more inputs or commands. In other such embodiments, computerized instructions for controlling any games displayed by the EGM are communicated from the central server, central controller, or remote host to the EGM and are stored in at least one memory device of the EGM. In such “thick client” embodiments, the at least one processor of the EGM executes the computerized instructions to control any games (or other suitable interfaces) displayed by the EGM.

In various embodiments in which the gaming system includes a plurality of EGMs, one or more of the EGMs are thin client EGMs and one or more of the EGMs are thick client EGMs. In other embodiments in which the gaming system includes one or more EGMs, certain functions of one or more of the EGMs are implemented in a thin client environment, and certain other functions of one or more of the EGMs are implemented in a thick client environment. In one such embodiment in which the gaming system includes an EGM and a central server, central controller, or remote host, computerized instructions for controlling any primary or base games displayed by the EGM are communicated from the central server, central controller, or remote host to the EGM in a thick client configuration, and computerized instructions for controlling any secondary or bonus games or other functions displayed by the EGM are executed by the central server, central controller, or remote host in a thin client configuration.

In certain embodiments in which the gaming system includes; (a) an EGM configured to communicate with a central server, central controller, or remote host through a data network; and/or (b) a plurality of EGMs configured to communicate with one another through a data network, the data network is a local area network (LAN) in which the EGMs are located substantially proximate to one another and/or the central server, central controller, or remote host. In one example, the EGMs and the central server, central controller, or remote host are located in a gaming establishment or a portion of a gaming establishment.

In other embodiments in which the gaming system includes: (a) an EGM configured to communicate with a central server, central controller, or remote host through a data network; and/or (b) a plurality of EGMs configured to communicate with one another through a data network, the data network is a wide area network (WAN) in which one or more of the EGMs are not necessarily located substantially proximate to another one of the EGMs and/or the central server, central controller, or remote host. For example, one or more of the EGMs are located: (a) in an area of a gaming establishment different from an area of the gaming establishment in which the central server, central controller, or remote host is located; or (b) in a gaming establishment different from the gaming establishment in which the central server, central controller, or remote host is located. In another example, the central server, central controller, or remote host is not located within a gaming establishment in which the EGMs are located. It should be appreciated that in certain embodiments in which the data network is a WAN, the gaming system includes a central server, central controller, or remote host and an EGM each located in a different gaming establishment in a same geographic area, such as a same city or a same state. It should be appreciated that gaming systems in which the data network is a WAN are substantially identical to gaming systems in which the data network is a LAN, though the quantity of EGMs in such gaming systems may vary relative to one another.

In further embodiments in which the gaming system includes: (a) an EGM configured to communicate with a central server, central controller, or remote host through a data network; and/or (b) a plurality of EGMs configured to communicate with one another through a data network, the data network is an internet or an intranet. In certain such embodiments, an internet browser of the EGM is usable to access an internet game page from any location where an internet connection is available. In one such embodiment, after the internet game page is accessed, the central server, central controller, or remote host identifies a player prior to enabling that player to place any wagers on any plays of any wagering games. In one example, the central server, central controller, or remote host identifies the player by requiring a player account of the player to be logged into via an input of a unique username and password combination assigned to the player. It should be appreciated, however, that the central server, central controller, or remote host may identify the player in any other suitable manner, such as by validating a player tracking identification number associated with the player; by reading a player tracking card or other smart card inserted into a card reader (as described below); by validating a unique player identification number associated with the player by the central server, central controller, or remote host; or by identifying the EGM, such as by identifying the MAC address or the IP address of the internet facilitator. In various embodiments, once the central server, central controller, or remote host identifies the player, the central server, central controller, or remote host enables placement of one or more wagers on one or more plays of one or more primary or base games and/or one or more secondary or bonus games, and displays those plays via the internet browser of the EGM.

It should be appreciated that the central server, central controller, or remote host and the EGM are configured to connect to the data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile internet network), or any other suitable medium. It should be appreciated that the expansion in the quantity of computing devices and the quantity and speed of internet connections in recent years increases opportunities for players to use a variety of EGMs to play games from an ever-increasing quantity of remote sites. It should also be appreciated that the enhanced bandwidth of digital wireless communications may render such technology suitable for some or all communications, particularly if such communications are encrypted. Higher data transmission speeds may be useful for enhancing the sophistication and response of the display and interaction with players.

### EGM Components

In various embodiments, an EGM includes at least one processor configured to operate with at least one memory device, at least one input device, and at least one output device. The at least one processor may be any suitable processing device or set of processing devices, such as a microprocessor, a microcontroller-based platform, a suitable integrated circuit, or one or more application-specific integrated circuits (ASICs). FIG. 43 illustrates an example EGM including a processor 1012.

As generally noted above, the at least one processor of the EGM is configured to communicate with, configured to access, and configured to exchange signals with at least one memory device or data storage device. In various embodiments, the at least one memory device of the EGM includes random access memory (RAM), which can include non-volatile RAM (NVRAM), magnetic RAM (MRAM), ferroelectric RAM (FeRAM), and other forms as commonly understood in the gaming industry. In other embodiments, the at least one memory device includes read only memory (ROM). In certain embodiments, the at least one memory device of the EGM includes flash memory and/or EEPROM (electrically erasable programmable read only memory). The example EGM illustrated in FIG. 4B includes a memory device 1014. It should be appreciated that any other suitable magnetic, optical, and/or semiconductor memory may operate in conjunction with the EGM disclosed herein. In certain embodiments, the at least one processor of the EGM and the at least one memory device of the EGM both reside within a cabinet of the EGM (as described below). In other embodiments, at least one of the at least one processor of the EGM and the at least one memory device of the EGM reside outside the cabinet of the EGM (as described below).

In certain embodiments, as generally described above, the at least one memory device of the EGM stores program code and instructions executable by the at least one processor of the EGM to control the EGM. The at least one memory device of the EGM also stores other operating data, such as image data, event data, input data, random number generators (RNGs) or pseudo-RNGs, paytable data or information, and/or applicable game rules that relate to the play of one or more games on the EGM (such as primary or base games and/or secondary or bonus games as described below). In various embodiments, part or all of the program code and/or the operating data described above is stored in at least one detachable or removable memory device including, but not limited to, a cartridge, a disk, a CD ROM, a DVD, USB memory device, or any other suitable non-transitory computer readable medium. In certain such embodiments, an operator (such as a gaming establishment operator) and/or a player uses such a removable memory device in an EGM to implement at least part of the present disclosure. In other embodiments, part or all of the program code and/or the operating data is downloaded to the at least one memory device of the EGM through any suitable data network described above (such as an internet or intranet).

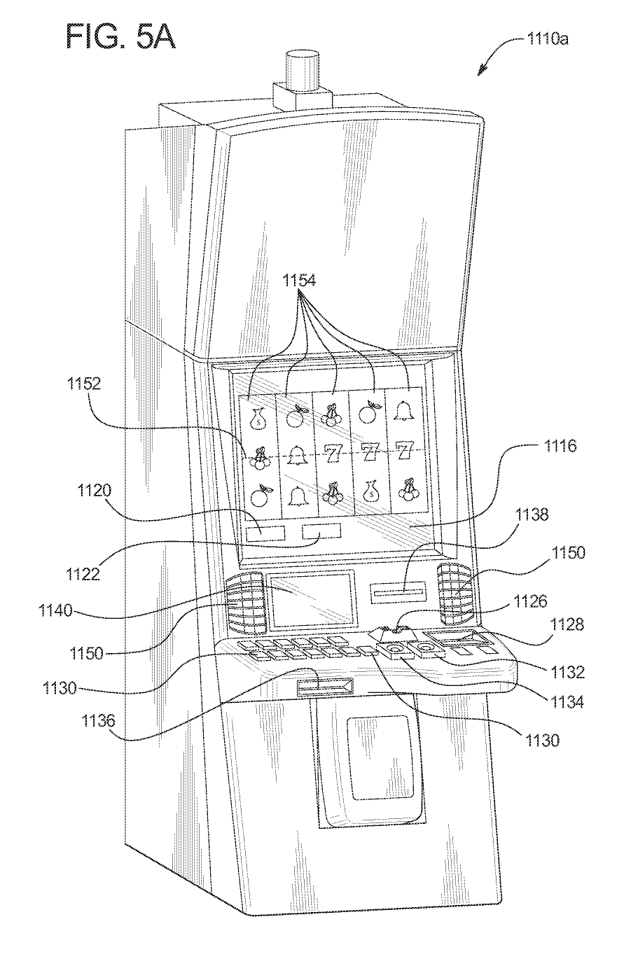

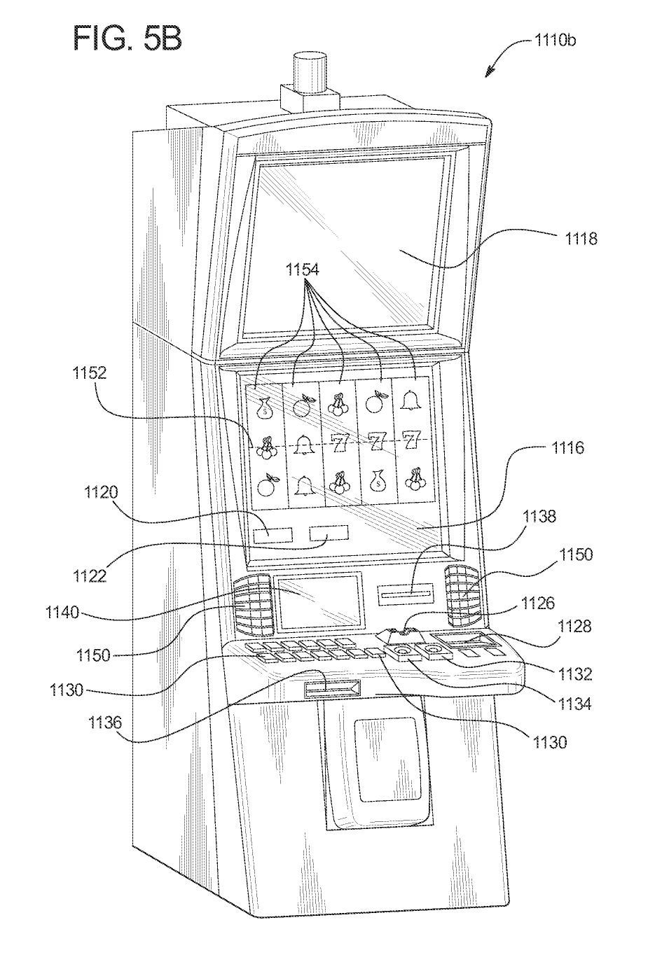

In various embodiments, the EGM includes one or more input devices. The input devices may include any suitable device that enables an input signal to be produced and received by the at least one processor of the EGM. The example EGM illustrated in FIG. 4B includes at least one input device 1030. One input device of the EGM is a payment device configured to communicate with the at least one processor of the EGM to fund the EGM. In certain embodiments, the payment device includes one or more of: (a) a bill acceptor into which paper money is inserted to fund the EGM; (b) a ticket acceptor into which a ticket or a voucher is inserted to fund the EGM; (c) a coin slot into which coins or tokens are inserted to fund the EGM; (d) a reader or a validator for credit cards, debit cards, or credit slips into which a credit card, debit card, or credit slip is inserted to fund the EGM; (e) a player identification card reader into which a player identification card is inserted to fund the EGM; or (f) any suitable combination thereof. FIGS. 5A and 5B illustrate example EGMs 1110a and 1110b that each include the following payment devices: (a) a combined bill and ticket acceptor 1128, and (b) a coin slot 1126.

In one embodiment, the EGM includes a payment device configured to enable the EGM to be funded via an electronic funds transfer, such as a transfer of funds from a bank account. In another embodiment, the EGM includes a payment device configured to communicate with a mobile device of a player, such as a cell phone, a radio frequency identification tag, or any other suitable wired or wireless device, to retrieve relevant information associated with that player to fund the EGM. It should be appreciated that when the EGM is funded, the at least one processor determines the amount of funds entered and displays the corresponding amount on a credit display or any other suitable display as described below.

In various embodiments, one or more input devices of the EGM are one or more game play activation devices that are each used to initiate a play of a game on the EGM or a sequence of events associated with the EGM following appropriate funding of the EGM. The example EGMs 1110a and 1110b illustrated in FIGS. 5A and 5B each include a game play activation device in the form of a game play initiation button 1132. It should be appreciated that, in other embodiments, the EGM begins game play automatically upon appropriate funding rather than upon utilization of the game play activation device.

In certain embodiments, one or more input devices of the EGM are one or more wagering or betting devices. One such wagering or betting device is as a maximum wagering or betting device that, when utilized, causes a maximum wager to be placed. Another such wagering or betting device is a repeat the bet device that, when utilized, causes the previously-placed wager to be placed. A further such wagering or betting device is a bet one device. A bet is placed upon utilization of the bet one device. The bet is increased by one credit each time the bet one device is utilized. Upon the utilization of the bet one device, a quantity of credits shown in a credit display (as described below) decreases by one, and a number of credits shown in a bet display (as described below) increases by one. The example EGMs 1110a and 1110b illustrated in FIGS. 5A and 5B each include one or more input devices 1130.

In other embodiments, one input device of the EGM is a cash out device. The cash out device is utilized to receive a cash payment or any other suitable form of payment corresponding to a quantity of remaining credits of a credit display (as described below). The example EGMs 1110a and 1110b illustrated in FIGS. 5A and 5B each include a cash out device in the form of a cash out button 1134.

In certain embodiments, one input device of the EGM is a touch-screen coupled to a touch-screen controller or other touch-sensitive display overlay to enable interaction with any images displayed on a display device (as described below). One such input device is a conventional touch-screen button panel. The touch-screen and the touch-screen controller are connected to a video controller. In these embodiments, signals are input to the EGM by touching the touch screen at the appropriate locations.

In various embodiments, one input device of the EGM is a sensor, such as a camera, in communication with the at least one processor of the EGM (and controlled by the at least one processor of the EGM in some embodiments) and configured to acquire an image or a video of a player using the EGM and/or an image or a video of an area surrounding the EGM.

In embodiments including a player tracking system, as further described below, one input device of the EGM is a card reader in communication with the at least one processor of the EGM. The example EGMs 1110a and 1110b illustrated in FIGS. 5A and 5B each include a card reader 1138. The card reader is configured to read a player identification card inserted into the card reader.

In various embodiments, the EGM includes one or more output devices. The example EGM illustrated in FIG. 4B includes at least one output device 1060. One or more output devices of the EGM are one or more display devices configured to display any game(s) displayed by the EGM and any suitable information associated with such game(s). In certain embodiments, the display devices are connected to or mounted on a cabinet of the EGM (as described below). In various embodiments, the display devices serves as digital glass configured to advertise certain games or other aspects of the gaming establishment in which the EGM is located. In various embodiments, the EGM includes one or more of the following display devices: (a) a central display device; (b) a player tracking display configured to display various information regarding a player's player tracking status (as described below); (c) a secondary or upper display device in addition to the central display device and the player tracking display; (d) a credit display configured to display a current quantity of credits, amount of cash, account balance, or the equivalent; and (e) a bet display configured to display an amount wagered for one or more plays of one or more games. The example EGM 1110a illustrated in FIG. 5A includes a central display device 1116, a player tracking display 1140, a credit display 1120, and a bet display 1122. The example EGM 1110b illustrated in FIG. 5B includes a central display device 1116, an upper display device 1118, a player tracking display 1140, a credit display 1120, and a bet display 1122.

In various embodiments, the display devices include, without limitation: a monitor, a television display, a plasma display, a liquid crystal display (LCD), a display based on light emitting diodes (LEDs), a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism. In certain embodiments, as described above, the display device includes a touch-screen with an associated touch-screen controller. It should be appreciated that the display devices may be of any suitable sizes, shapes, and configurations.

The display devices of the EGM are configured to display one or more game and/or non-game images, symbols, and indicia. In certain embodiments, the display devices of the EGM are configured to display any suitable visual representation or exhibition of the movement of objects; dynamic lighting; video images; images of people, characters, places, things, and faces of cards; and the like. In certain embodiments, the display devices of the EGM are configured to display one or more video reels, one or more video wheels, and/or one or more video dice. In other embodiments, certain of the displayed images, symbols, and indicia are in mechanical form. That is, in these embodiments, the display device includes any electromechanical device, such as one or more rotatable wheels, one or more reels, and/or one or more dice, configured to display at least one or a plurality of game or other suitable images, symbols, or indicia.

In various embodiments, one output device of the EGM is a payout device. In these embodiments, when the cash out device is utilized as described above, the payout device causes a payout to be provided to the player. hi one embodiment, the payout device is one or more of: (a) a ticket generator configured to generate and provide a ticket or credit slip representing a payout, wherein the ticket or credit slip may be redeemed via a cashier, a kiosk, or other suitable redemption system; (b) a note generator configured to provide paper currency; (c) a coin generator configured to provide coins or tokens in a coin payout tray; and (d) any suitable combination thereof. The example EGMs illustrated in FIGS. 5A and 5B each include ticket generator 1136. In one embodiment, the EGM includes a payout device configured to fund an electronically recordable identification card or smart card or a bank account via an electronic funds transfer.

In certain embodiments, one output device of the EGM is a sound generating device controlled by one or more sound cards. hi one such embodiment, the sound generating device includes one or more speakers or other sound generating hardware and/or software for generating sounds, such as by playing music for any games or by playing music for other modes of the EGM, such as an attract mode. The example EGMs illustrated in FIGS. 5A and 5B each include a plurality of speakers 1150. In another such embodiment, the EGM provides dynamic sounds coupled with attractive multimedia images displayed on one or more of the display devices to provide an audio-visual representation or to otherwise display full-motion video with sound to attract players to the EGM. In certain embodiments, the EGM displays a sequence of audio and/or visual attraction messages during idle periods to attract potential players to the EGM. The videos may be customized to provide any appropriate information.

In various embodiments, the EGM includes a plurality of communication ports configured to enable the at least one processor of the EGM to communicate with and to operate with external peripherals, such as: accelerometers, arcade sticks, bar code readers, bill validators, biometric input devices, bonus devices, button panels, card readers, coin dispensers, coin hoppers, display screens or other displays or video sources, expansion buses, information panels, keypads, lights, mass storage devices, microphones, motion sensors, motors, printers, reels, SCSI ports, solenoids, speakers, thumbsticks, ticket readers, touch screens, trackballs, touchpads, wheels, and wireless communication devices. At least U.S. Patent Application Publication No. 2004/0254014 describes a variety of EGMs including one or more communication ports that enable the EGMs to communicate and operate with one or more external peripherals.

As generally described above, in certain embodiments, such as the example EGMs 1110a and 1110b illustrated in FIGS. 5A and 5B, the EGM has a support structure, housing, or cabinet that provides support for a plurality of the input device and the output devices of the EGM. Further, the EGM is configured such that a player may operate it while standing or sitting. In various embodiments, the EGM is positioned on a base or stand, or is configured as a pub-style tabletop game (not shown) that a player may operate typically while sitting. As illustrated by the different example EGMs 1110a and 1110b shown in FIGS. 5A and 5B, EGMs may have varying cabinet and display configurations.

It should be appreciated that, in certain embodiments, the EGM is a device that has obtained approval from a regulatory gaming commission, and in other embodiments, the EGM is a device that has not obtained approval from a regulatory gaming commission.

As explained above, for brevity and clarity, both the EGMs and the personal gaming devices of the present disclosure are collectively referred to herein as “EGMs.” Accordingly, it should be appreciated that certain of the example EGMs described above include certain elements that may not be included in all EGMs. For example, the payment device of a personal gaming device such as a mobile telephone may not include a coin acceptor, while in certain instances the payment device of an EGM located in a gaming establishment may include a coin acceptor.

Operation of Primary or Base Games and/or Secondary or Bonus Games

In various embodiments, an EGM may be implemented in one of a variety of different configurations. In various embodiments, the EGM may be implemented as one of: (a) a dedicated EGM wherein computerized game programs executable by the EGM for controlling any primary or base games (referred to herein as “primary games”) and/or any secondary or bonus games or other functions (referred to herein as “secondary games”) displayed by the EGM are provided with the EGM prior to delivery to a gaming establishment or prior to being provided to a player; and (b) a changeable EGM wherein computerized game programs executable by the EGM for controlling any primary games and/or secondary games displayed by the EGM are downloadable to the EGM through a data network or remote communication link after the EGM is physically located in a gaming establishment or after the EGM is provided to a player.

As generally explained above, in various embodiments in which the gaming system includes a central server, central controller, or remote host and a changeable EGM, the at least one memory device of the central server, central controller, or remote host stores different game programs and instructions executable by the at least one processor of the changeable EGM to control one or more primary games and/or secondary games displayed by the changeable EGM. More specifically, each such executable game program represents a different game or a different type of game that the at least one changeable EGM is configured to operate. In one example, certain of the game programs are executable by the changeable EGM to operate games having the same or substantially the same game play but different paytables. In different embodiments, each executable game program is associated with a primary game, a secondary game, or both. In certain embodiments, an executable game program is executable by the at least one processor of the at least one changeable EGM as a secondary game to be played simultaneously with a play of a primary game (which may be downloaded to or otherwise stored on the at least one changeable EGM), or vice versa.

In operation of such embodiments, the central server, central controller, or remote host is configured to communicate one or more of the stored executable game programs to the at least one processor of the changeable EGM. In different embodiments, a stored executable game program is communicated or delivered to the at least one processor of the changeable EGM by: (a) embedding the executable game program in a device or a component (such as a microchip to be inserted into the changeable EGM); (b) writing the executable game program onto a disc or other media; or (c) uploading or streaming the executable game program over a data network (such as a dedicated data network). After the executable game program is communicated from the central server, central controller, or remote host to the changeable EGM, the at least one processor of the changeable EGM executes the executable game program to enable the primary game and/or the secondary game associated with that executable game program to be played using the display device(s) and/or the input device(s) of the changeable EGM. That is, when an executable game program is communicated to the at least one processor of the changeable EGM, the at least one processor of the changeable EGM changes the game or the type of game that may be played using the changeable EGM.

In certain embodiments, the gaming system randomly determines any game outcome(s) (such as a win outcome) and/or award(s) (such as a quantity of credits to award for the win outcome) for a play of a primary game and/or a play of a secondary game based on probability data. In certain such embodiments, this random determination is provided through utilization of an RNG, such as a true RNG or a pseudo RNG, or any other suitable randomization process. In one such embodiment, each game outcome or award is associated with a probability, and the gaming system generates the game outcome(s) and/or the award(s) to be provided based on the associated probabilities. In these embodiments, since the gaming system generates game outcomes and/or awards randomly or based on one or more probability calculations, there is no certainty that the gaming system will ever provide any specific game outcome and/or award.

In certain embodiments, the gaming system maintains one or more predetermined pools or sets of predetermined game outcomes and/or awards. In certain such embodiments, upon generation or receipt of a game outcome and/or award request, the gaming system independently selects one of the predetermined game outcomes and/or awards from the one or more pools or sets. The gaming system flags or marks the selected game outcome and/or award as used. Once a game outcome or an award is flagged as used, it is prevented from further selection from its respective pool or set; that is, the gaming system does not select that game outcome or award upon another game outcome and/or award request. The gaming system provides the selected game outcome and/or award. At least U.S. Pat. Nos. 7,470,183; 7,563,163; and 7,833,092 and U.S. Patent Application Publication Nos. 2005/0148382, 2006/0094509, and 2009/0181743 describe various examples of this type of award determination,

In certain embodiments, the gaming system determines a predetermined game outcome and/or award based on the results of a bingo, keno, or lottery game. In certain such embodiments, the gaming system utilizes one or more bingo, keno, or lottery games to determine the predetermined game outcome and/or award provided for a primary game and/or a secondary game. The gaming system is provided or associated with a bingo card. Each bingo card consists of a matrix or array of elements, wherein each element is designated with separate indicia. After a bingo card is provided, the gaming system randomly selects or draws a plurality of the elements. As each element is selected, a determination is made as to whether the selected element is present on the bingo card. If the selected element is present on the bingo card, that selected element on the provided bingo card is marked or flagged. This process of selecting elements and marking any selected elements on the provided bingo cards continues until one or more predetermined patterns are marked on one or more of the provided bingo cards. After one or more predetermined patterns are marked on one or more of the provided bingo cards, game outcome and/or award is determined based, at least in part, on the selected elements on the provided bingo cards. At least U.S. Pat. Nos. 7,753,774; 7,731,581; 7,955,170; and 8,070,579 and U.S. Patent Application Publication No. 2011/0028201 describe various examples of this type of award determination.

In certain embodiments in which the gaming system includes a central server, central controller, or remote host and an EGM, the EGM is configured to communicate with the central server, central controller, or remote host for monitoring purposes only. In such embodiments, the EGM determines the game outcome(s) and/or award(s) to be provided in any of the manners described above, and the central server, central controller, or remote host monitors the activities and events occurring on the EGM. In one such embodiment, the gaming system includes a real-time or online accounting and gaming information system configured to communicate with the central server, central controller, or remote host. In this embodiment, the accounting and gaming information system includes: (a) a player database for storing player profiles, (b) a player tracking module for tracking players (as described below), and (c) a credit system for providing automated transactions. At least U.S. Pat. No. 6,913,534 and U.S. Patent Application Publication No. 2006/0281541 describe various examples of such accounting systems.

As noted above, in various embodiments, the gaming system includes one or more executable game programs executable by at least one processor of the gaming system to provide one or more primary games and one or more secondary games. The primary game(s) and the secondary game(s) may comprise any suitable games and/or wagering games, such as, but not limited to: electro-mechanical or video slot or spinning reel type games; video card games such as video draw poker, multi-hand video draw poker, other video poker games, video blackjack games, and video baccarat games; video keno games; video bingo games; and video selection games.

In certain embodiments in which the primary game is a slot or spinning reel type game, the gaming system includes one or more reels in either an electromechanical form with mechanical rotating reels or in a video form with simulated reels and movement thereof. Each reel displays a plurality of indicia or symbols, such as bells, hearts, fruits, numbers, letters, bars, or other images that typically correspond to a theme associated with the gaming system. In certain such embodiments, the gaming system includes one or more paylines associated with the reels. The example EGMs 1110a and 1110b shown in FIGS. 5A and 5B include a plurality of paylines 1152 and a plurality of reels 1154. In certain embodiments, one or more of the reels are independent reels or unisymbol reels. In such embodiments, each independent reel generates and displays one symbol.

In various embodiments, one or more of the paylines is horizontal, vertical, circular, diagonal, angled, or any suitable combination thereof. In other embodiments, each of one or more of the paylines is associated with a plurality of adjacent symbol display areas on a requisite number of adjacent reels. In one such embodiment, one or more paylines are formed between at least two symbol display areas that are adjacent to each other by either sharing a common side or sharing a common corner (i.e., such paylines are connected paylines). The gaming system enables a wager to be placed on one or more of such paylines to activate such paylines. In other embodiments in which one or more paylines are formed between at least two adjacent symbol display areas, the gaming system enables a wager to be placed on a plurality of symbol display areas, which activates those symbol display areas.

In various embodiments, the gaming system provides one or more awards after a spin of the reels when specified types and/or configurations of the indicia or symbols on the reels occur on an active payline or otherwise occur in a winning pattern, occur on the requisite number of adjacent reels, and/or occur in a scatter pay arrangement.

In certain embodiments, the gaming system employs a ways to win award determination. In these embodiments, any outcome to be provided is determined based on a number of associated symbols that are generated in active symbol display areas on the requisite number of adjacent reels (i.e., not on paylines passing through any displayed winning symbol combinations). If a winning symbol combination is generated on the reels, one award for that occurrence of the generated winning symbol combination is provided. At least U.S. Pat. No. 8,012,011 and U.S. Patent Application Publication Nos. 2008/0108408 and 200810132320 describe various examples of ways to win award determinations.

In various embodiments, the gaming system includes a progressive award. Typically, a progressive award includes an initial amount and an additional amount funded through a portion of each wager placed to initiate a play of a primary game. When one or more triggering events occurs, the gaming system provides at least a portion of the progressive award. After the gaming system provides the progressive award, an amount of the progressive award is reset to the initial amount and a portion of each subsequent wager is allocated to the next progressive award. At least U.S. Pat. Nos. 5,766,079; 7,585,223; 7,651,392; 7,666,093; 7,780,523; and 7,905,778 and U.S. Patent Application Publication Nos. 2008/0020846, 2009/0123364, 2009/0123363, and 2010/0227677 describe various examples of different progressive gaming systems.

As generally noted above, in addition to providing winning credits or other awards for one or more plays of the primary game(s), in various embodiments the gaming system provides credits or other awards for one or more plays of one or more secondary games. The secondary game typically enables an award to be obtained addition to any award obtained through play of the primary game(s). The secondary game(s) typically produces a higher level of player excitement than the primary game(s) because the secondary game(s) provides a greater expectation of winning than the primary game(s) and is accompanied with more attractive or unusual features than the primary game(s). R should be appreciated that the secondary game(s) may be any type of suitable game, either similar to or completely different from the primary game.

In various embodiments, the gaming system automatically provides or initiates the secondary game upon the occurrence of a triggering event or the satisfaction of a qualifying condition. In other embodiments, the gaming system initiates the secondary game upon the occurrence of the triggering event or the satisfaction of the qualifying condition and upon receipt of an initiation input. In certain embodiments, the triggering event or qualifying condition is a selected outcome in the primary game(s) or a particular arrangement of one or more indicia on a display device for a play of the primary game(s), such as a “BONUS” symbol appearing on three adjacent reels along a payline following a spin of the reels for a play of the primary game. In other embodiments, the triggering event or qualifying condition occurs based on a certain amount of game play (such as number of games, number of credits, amount of time) being exceeded, or based on a specified number of points being earned during game play. It should be appreciated that any suitable triggering event or qualifying condition or any suitable combination of a plurality of different triggering events or qualifying conditions may be employed.

In other embodiments, at least one processor of the gaming system randomly determines when to provide one or more plays of one or more secondary games. In one such embodiment, no apparent reason is provided for the providing of the secondary game. In this embodiment, qualifying for a secondary game is not triggered by the occurrence of an event in any primary game or based specifically on any of the plays of any primary game. That is, qualification is provided without any explanation or, alternatively, with a simple explanation. In another such embodiment, the gaming system determines qualification for a secondary game at least partially based on a game triggered or symbol triggered event, such as at least partially based on play of a primary game.

In various embodiments, after qualification for a secondary game has been determined, the secondary game participation may be enhanced through continued play on the primary game. Thus, in certain embodiments, for each secondary game qualifying event, such as a secondary game symbol, that is obtained, a given number of secondary game wagering points or credits is accumulated in a “secondary game meter” configured to accrue the secondary game wagering credits or entries toward eventual participation in the secondary game. In one such embodiment, the occurrence of multiple such secondary game qualifying events in the primary game results in an arithmetic or exponential increase in the number of secondary game wagering credits awarded. In another such embodiment, any extra secondary game wagering credits may be redeemed during the secondary game to extend play of the secondary game.

In certain embodiments, no separate entry fee or buy-in for the secondary game is required. That is, entry into the secondary game cannot be purchased; rather, in these embodiments entry must be won or earned through play of the primary game, thereby encouraging play of the primary game. In other embodiments, qualification for the secondary game is accomplished through a simple “buy-in.” For example, qualification through other specified activities is unsuccessful, payment of a fee or placement of an additional wager “buys-in” to the secondary game. In certain embodiments, a separate side wager must be placed on the secondary game or a wager of a designated amount must be placed on the primary game to enable qualification for the secondary game. In these embodiments, the secondary game triggering event must occur and the side wager (or designated primary game wager amount) must have been placed for the secondary game to trigger.

In various embodiments in which the gaming system includes a plurality of EGMs, the EGMs are configured to communicate with one another to provide a group gaming environment. In certain such embodiments, the EGMs enable players of those EGMs to work in conjunction with one another, such as by enabling the players to play together as a team or group, to win one or more awards. In other such embodiments, the EGMs enable players of those EGMs to compete against one another for one or more awards. In one such embodiment, the EGMs enable the players of those EGMs to participate in one or more gaming tournaments for one or more awards. At least U.S. Patent Application Publication Nos. 2007/0123341, 2008/0070680, 2008/0176650, and 2009/0124363 describe various examples of different group gaming systems.

In various embodiments, the gaming system includes one or more player tracking systems. Such player tracking systems enable operators of the gaming system (such as casinos or other gaming establishments) to recognize the value of customer loyalty by identifying frequent customers and rewarding them for theft patronage. Such a player tracking system is configured to track a players gaming activity. In one such embodiment, the player tracking system does so through the use of player tracking cards. In this embodiment, a player is issued a player identification card that has an encoded player identification number that uniquely identifies the player. When the player's playing tracking card is inserted into a card reader of the gaming system to begin a gaming session, the card reader reads the player identification number off the player tracking card to identify the player. The gaming system timely tracks any suitable information or data relating to the identified player's gaming session. The gaming system also timely tracks when the player tracking card is removed to conclude play for that gaming session. In another embodiment, rather than requiring insertion of a player tracking card into the card reader, the gaming system utilizes one or more portable devices, such as a cell phone, a radio frequency identification tag, or any other suitable wireless device, to track when a gaming session begins and ends. In another embodiment, the gaming system utilizes any suitable biometric technology or ticket technology to track when a gaming session begins and ends.

In such embodiments, during one or more gaming sessions, the gaming system tracks any suitable information or data, such as any amounts wagered, average wager amounts, and/or the time at which these wagers are placed. In different embodiments, for one or more players, the player tracking system includes the player's account number, the player's card number, the player's first name, the player's surname, the player's preferred name, the player's player tracking ranking, any promotion status associated with the player's player tracking card, the player's address, the player's birthday, the player's anniversary, the player's recent gaming sessions, or any other suitable data. In various embodiments, such tracked information and/or any suitable feature associated with the player tracking system is displayed on a player tracking display. In various embodiments, such tracked information and/or any suitable feature associated with the player tracking system is displayed via one or more service windows that are displayed on the central display device and/or the upper display device. At least U.S. Pat. Nos. 6,722,985; 6,908,387; 7,311,605; 7,611,411; 7,617,151; and 8,057,298 describe various examples of player tracking systems.

It should be understood that various changes and modifications to the present embodiments described herein will be apparent to those skilled in the art. Such changes and modifications can be made without departing from the spirit and scope of the present subject matter and without diminishing its intended advantages. It is therefore intended that such changes and modifications be covered by the appended claims

The invention is claimed as follows:

1. A gaming system comprising:
at least one display device;
at least one input device;
at least one processor; and
at least one memory device which stores a plurality of instructions, which when executed by the at least one processor, cause the at least one processor to operate with the at least one display device and the at least one input device, to:
(a) randomly cause a game modifier triggering event to occur;
(b) upon the occurrence of the game modifier triggering event:
(i) cause a game modifier generator to randomly select one of a plurality of different game modifiers;
(ii) determine an activation duration of the selected game modifier;
(iii) activate the selected game modifier for the determined activation duration;
(c) during the determined activation duration, receive a wager placed on a play of a game;
(d) for the wagered on play of the game:
(i) modify at least one parameter of the play of the game, said modified at least one parameter based on each of the activated game modifiers;
(ii) determine a game outcome;
(iii) display the determined game outcome;
(iv) determine any award associated with the determined game outcome; and
(v) display the determined award, wherein at least one of the determined game outcome and any determined award is based on the modified at least one parameter.

2. The gaming system of claim 1, wherein for a wagered on play of the game not during any determined activation duration:
(i) determine a game outcome;
(ii) display the determined game outcome;
(iii) determine any award associated with the determined game outcome; and
(iv) display the determined award, wherein both the determined outcome and the determined award are not based on any modified parameters.

3. The gaming system of claim 1, wherein the determined activation duration is a period of time.

4. The gaming system of claim 1, wherein the determined activation duration is a quantity of plays of the game.

5. The gaming system of claim 1, wherein the determined activation duration of the selected game modifier is based, at least in part, on the wager placed on the play of the game.

6. The gaming system of claim 1, wherein a frequency of the occurrence of the game modifier triggering event is based, at least in part, on the wager placed on the play of the game.

7. The gaming system of claim 1, wherein the displayed game outcome includes a symbol combination selected from a plurality of symbols and at least one game modifier is selected from the group consisting of: at least one symbol from the plurality of symbols functioning as a wild symbol, at least one symbol added to the plurality of symbols associated with a feature, and a credit amount.

8. The gaming system of claim 7, wherein the feature is at least one selected from the group consisting of: a multiplier symbol and a bonus game trigger symbol.

9. A method of operating a gaming system, said method comprising:
(a) causing at least one processor to execute a plurality of instructions to randomly cause a game modifier triggering event to occur;
(b) upon the occurrence of the game modifier triggering event:
(i) causing the at least one processor to execute the plurality of instructions to cause a game modifier generator to randomly select one of a plurality of different game modifiers;
(ii) causing the at least one processor to execute the plurality of instructions to determine an activation duration of the selected game modifier;
(iii) causing the at least one processor to execute the plurality of instructions to activate the selected game modifier for the determined activation duration;
(c) during the determined activation duration, causing the at least one processor to execute the plurality of instructions to operate with at least one input device to receive a wager placed on a play of a game;
(d) for the wagered on play of the game:
(i) causing the at least one processor to execute the plurality of instruction to modify at least one parameter of the play of the game, said modified at least one parameter based on each of the activated game modifiers;
(ii) causing the at least one processor to execute the plurality of instruction to determine a game outcome;
(iii) causing the at least one processor to operate with at least one display device to display the determined game outcome;
(iv) causing the at least one processor to execute the plurality of instruction to determine any award associated with the determined game outcome; and
(v) causing the at least one processor to operate with the display device to display the determined award, wherein at least one of the determined game outcome and any determined award is based on the modified at least one parameter.

10. The method of claim 9, wherein for a wagered on play of the game not during any activation duration:
(i) causing the at least one processor to execute the plurality of instruction to determine a game outcome;
(ii) causing the at least one processor to operate with at least one display device to display the determined game outcome;
(iii) causing the at least one processor to execute the plurality of instruction to determine any award associated with the determined game outcome; and
(vi) causing the at least one processor to operate with the display device to display the determined award, wherein both the determined outcome and the determined award are not based on any modified parameters.

11. The method of claim 9, wherein the determined activation duration is a period of time.

12. The method of claim 9, wherein the determined activation duration is a quantity of plays of the game.

13. The method of claim 9, wherein the determined activation duration of the selected game modifier is based, at least in part, on the wager placed on the play of the game.

14. The method of claim 9, wherein a frequency of the occurrence of the game modifier triggering event is based, at least in part, on the wager placed by the player.

15. The method of claim 9, wherein the displayed game outcome includes a symbol combination selected from a plurality of symbols and at least one game modifier is selected from the group consisting of: at least one symbol from the plurality of symbols functioning as a wild symbol, at least one symbol added to the plurality of symbols associated with a feature, and a credit amount.

16. The method of claim 15, wherein the feature is at least one selected from the group consisting of: a multiplier symbol and a bonus game trigger symbol.

17. The method of claim 9, which transmits and receives data over a data network.

18. The method of claim 17, wherein the data network is an internet.

19. A non-transitory computer readable medium storing a plurality of instructions which, when executed by at least one processor, cause the at least one processor to operate with at least one display device and at least one input device to:
(a) randomly cause a game modifier triggering event to occur;
(b) upon the occurrence of the game modifier triggering event:
(i) cause a game modifier generator to randomly select one of a plurality of different game modifiers;
(ii) determine an activation duration of the selected game modifier;
(iii) activate the selected game modifier for the determined activation duration;
(c) during the determined activation duration, receive a wager placed on a play of a game; and
(d) for the wagered on play of the game:
(i) modify at least one parameter of the play of the game, said modified at least one parameter based on each of the activated game modifiers;
(ii) determine a game outcome;
(iii) display the determined game outcome;
(iv) determine any award associated with the determined game outcome; and
(v) display the determined award, wherein at least one of the determined game outcome and any determined award is based on the modified at least one parameter.

20. The non-transitory computer readable medium of claim 19, wherein for a wagered on play of the game not during any determined activation duration:
(i) determine a game outcome;
(ii) display the determined game outcome;
(iii) determine any award associated with the determined game outcome; and
(iv) display the determined award wherein both the determined outcome and the determined award are not based on any modified parameters.

21. The non-transitory computer readable medium of claim 19, wherein the determined activation duration is a period of time.

22. The non-transitory computer readable medium of claim 19, wherein the determined activation duration is a quantity of plays of the game.

23. The non-transitory computer readable medium of claim 19, wherein the determined activation duration of the selected game modifier is based, at least in part, on the wager placed on the play of the game.

24. The non-transitory computer readable medium of claim 19, wherein a frequency of the occurrence of the game modifier triggering event is based, at least in part, on the wager placed on the play of the game.

25. The non-transitory computer readable medium of claim 19, wherein the displayed game outcome includes a symbol combination selected from a plurality of symbols and at least one game modifier is selected from the group consisting of: at least one symbol from the plurality of symbols functioning as a wild symbol, at least one symbol added to the plurality of symbols associated with a feature, and a credit amount.

26. The non-transitory computer readable medium of claim 25, wherein the feature is at least one selected from the group consisting of: a multiplier symbol and a bonus game trigger symbol.
